(19) United States
(12) Patent Application Publication
(10) Pub. No.: US 2026/0251624 A1
(43) Pub. Date: Aug. 27, 2026

(54) FLOW-RESTRICTED PNEUMATIC MODULATOR FOR A MULTIDIMENSIONAL GAS CHROMATOGRAPHY SYSTEM

(71) Applicant: The Regents of The University of Michigan, Ann Arbor, MI (US)

(72) Inventors: Xudong FAN, Ann Arbor, MI (US); Xiaolu HUANG, Shanghai (CN); Xiaheng HUANG, Ann Arbor, MI (US); Maxwell LI, Troy, MI (US)

(73) Assignee: The Regents of The University of Michigan, Ann Arbor, MI (US)

(21) Appl. No.: 18/877,085

(22) PCT Filed: Jun. 22, 2023
(86) PCT No.: PCT/US2023/025987

§ 371 Date: Dec. 19, 2024

Related U.S. Application Data
(60) Provisional application No. 63/354,520, filed on Jun. 22, 2022.

(51) Int. Cl. G01N 30/64; G01N 30/26; G01N 30/32; G01N 30/46

(52) U.S. Cl. CPC G01N 30/64; G01N 30/26; G01N 30/32; G01N 30/463; G01N 2030/642

(57) ABSTRACT

A flow-restricted pneumatic modulator (FRPM) assembly for a multidimensional gas chromatography system comprises a first y-shaped fluid connector having a first inlet receiving a stream from a first chromatographic column, a first channel having a flow resistor component and a first outlet, and a second channel having a second outlet in fluid communication a downstream bypass line. The FRPM assembly also has a second y-shaped fluid connector having a second inlet in fluid communication with the first outlet, a third inlet in communication with an auxiliary flow, and a third channel having a third outlet in fluid communication with a second chromatographic column. The FRPM assembly also has at least one flow control valve and can operate as an injector and a modulator to the second chromatographic column. Methods of chromatographic analysis of a fluid sample comprising one or more target analytes in a multidimensional chromatography system are also provided.

### CROSS-REFERENCE TO RELATED APPLICATIONS

This PCT International Application claims the benefit of U.S. Provisional Application No. 63/354,520 filed on Jun. 22, 2022. The entire disclosure of the above application is incorporated herein by reference.

### GOVERNMENT SUPPORT

This invention was made with government support under OH011082 awarded by the U.S. Centers for Disease Control and Prevention, under TR003812 awarded by the National Institutes of Health, and under FA8650-19-C-9101 awarded by the Office of the Director of National Intelligence-Intelligence Advanced Research Projects Activity. The government has certain rights in the invention.

### FIELD

The present disclosure relates to a flow-restricted pneumatic modulator for a multidimensional gas chromatography system and methods for conducting multidimensional chromatography analysis with such a flow-restricted pneumatic modulator.

### BACKGROUND

This section provides background information related to the present disclosure which is not necessarily prior art.

Micro-gas chromatography (μGC) is conducted on a miniaturized scale as compared to traditional gas chromatography. μGC is a powerful portable vapor analysis method for applications such as environmental protection and monitoring, workplace hazardous analysis, and biomedicine. To date, nearly all μGC devices are one dimensional (1D) GC with relatively short columns (<10 m), which limits the separation performance for complex mixtures for many field applications (e.g., petroleum, food, metabolomic or forensic), which may require separation of hundreds of diverse compounds. Thus, the addition of a second column in two dimensional (2D) GC, such as heart-cutting or comprehensive 2D GC, is needed to further enhance the separation capabilities and broaden the range of compounds that can be analyzed by a single portable μGC device.

Multidimensional gas chromatography systems include at least two distinct chromatographic columns in series. One specific type of μGC is comprehensive two-dimensional (2-D) gas chromatography (“GC×GC”), which is well-suited to analysis and separation of complex mixtures of volatile and/or semi-volatile compounds. Generally, comprehensive 2-D GC utilizes two columns of differing selectivities connected in series by an injector device. Typically, in a GC×GC separation, the sample is introduced via injection into a first chromatographic column. The target analyte species elute from this first column and can be trapped or periodically sampled by a downstream injector device. In a 2-D GC device, an injector that is disposed between the first-dimensional column and the second-dimensional column is an important component. The injector cuts a portion of an eluent from the first-dimensional GC column and injects it into the second-dimensional column for further analysis. When the injector performs the above operation periodically, it is also called “modulator,” which is commonly used in comprehensive 2-D GC.

The injector or modulator device is disposed between the first column (¹D) and the second column (²D), and serves to continuously trap, focus, and re-inject components eluted from the first column into the second column (as a continuous injector for the second column). Thus, after collecting the eluted species from the first column, typical modulators periodically inject the collected contents into a second column at a predetermined regular interval (e.g., usually at intervals ranging from 2 to 5 seconds). Such injected fractions can be separated in the second column and elute into a downstream detector, where they can be identified and/or measured.

In general, there are two types of modulators: (1) a thermal modulator and (2) a pneumatic modulator. A thermal modulator relies on a trap to first cut and trap a portion (for example, 2 seconds) of the eluent from the first-dimensional column and then inject the trapped analytes in a sharp peak into the second-dimensional column by quickly raising the temperature. Further, the thermal modulator needs to be cooled immediately in order to trap the subsequent eluent from the first-dimensional column. The major drawbacks of the thermal modulator are the need for (1) high power for rapid temperature ramping and (2) rapid cooling mechanisms (usually based on thermal-electric cooling effect or using liquid nitrogen or CO₂), which makes the modulator bulky and difficult to operation. These increase the modulator footprint and therefore are not suitable for μGC development. In addition, due to the thermal mass, the injection peak width is limited. While a microfabricated thermal modulator using thermal-electric cooling was recently demonstrated, it was still power intensive, difficult to fabricate and maintain, and incapable of trapping light compounds.

In contrast, a pneumatic modulator relies on auxiliary flows to control the injection of the eluent from the first-dimensional column into the second-dimensional column. A pneumatic modulator uses external valves and auxiliary flows to inject a portion of an eluent from the first-dimensional column into the second-dimensional column without rapid heating or cooling. The advantages of the pneumatic modulator include (1) no need for rapid temperature increases and decreases and (2) sharper injection peaks (e.g., the peak width is limited by the valves that control the switching of auxiliary flows). A few types of conventional pneumatic modulators are commonly used. The first is the stop-flow modulator, in which the flow in first-dimensional (¹D) column is suspended temporarily when second-dimensional (²D) column separation takes place. While the stop-flow modulator (essentially a T-junction) can be microfabricated, use of stop-flow mode significantly increases the first-dimensional (¹D) column separation time and causes additional peak broadening. Pneumatic flow switching modulators like Deans switches are also commonly used and have been microfabricated for comprehensive 2D GC. While the Deans switch allows for continuous first-dimensional (¹D) column separation concomitant with second-dimensional (²D) column separation, the flow rates in first-dimensional (¹D) column and second-dimensional (²D) column need to be carefully adjusted to avoid backflow in first-dimensional (¹D) column. Additionally, the analyte concentration in second-dimensional (²D) column is diluted due to the auxiliary flow needed to transfer the first-dimensional (¹D) column eluent to second-dimensional (²D) column. Differential flow modulators use 4- or 6-port valves so that the first-dimensional (¹D) column and second-dimensional (²D) column flows are independent and thus allow for concomitant first-dimensional (¹D) column and second-dimensional (²D) column separation while permitting a high second-dimensional (²D) column to first-dimensional (¹D) column flow rate ratio for sharp second-dimensional (²D) column injection and improved second-dimensional (²D) column separation. However, 4- and 6-port valves are very bulky and heavy, which are unsuitable for μGC. Thus, it would be desirable to develop a pneumatic modulator for a multidimensional gas chromatography system that is relatively lightweight and compact, while providing superior performance.

### SUMMARY

This section provides a general summary of the disclosure, and is not a comprehensive disclosure of its full scope or all of its features.

In certain aspects the present disclosure relates to a flow-restricted pneumatic modulator (FRPM) assembly for a multidimensional gas chromatography system. The FRPM assembly may comprise a first y-shaped fluid connector. The first y-shaped fluid connector has a first inlet, a first channel having a first outlet, and a second channel having a second outlet. The first inlet is configured to receive a stream from a first chromatographic column. The first outlet is configured to be in fluid communication with a second chromatographic column. The second outlet is configured to be in fluid communication a downstream bypass line. The FRPM assembly also comprises a first flow resistor component disposed in the first channel having a first flow resistance to the stream. The second channel has a second flow resistance that is less than the first flow resistance. The FRPM assembly also has at least one flow control valve in fluid communication with the second outlet of the first y-shaped fluid connector. The FRPM assembly further comprises a second y-shaped fluid connector having a second inlet and a third inlet that are connected to a third channel having a third outlet. The second inlet is in fluid communication with the first outlet of the first y-shaped fluid connector and configured to receive the stream from the first chromatographic column. The third inlet is configured to be in fluid communication with an auxiliary flow conduit upstream of the flow-restricted pneumatic modulator assembly and the third outlet is configured to be in fluid communication with the second chromatographic column. The flow-restricted pneumatic modulator assembly is configured to be operated as an injector and a modulator to the second chromatographic column.

In one aspect, the second channel comprises a second flow resistor component exhibiting the second flow resistance.

In one aspect, the FRPM assembly is formed on a substrate.

In one aspect, the at least one flow control valve is a first flow control valve and the flow-restricted pneumatic modulator assembly further comprises a second flow control valve upstream of and in fluid communication with the third inlet of the second y-shaped fluid connector.

In one further aspect, the first flow control valve and the second flow control valve are respectively two-port valves each having an open position and a closed position.

In one further aspect, in a first operational mode of the FRPM assembly, the first flow control valve and the second flow control valve are closed to direct the stream through the first channel, the first flow resistor component, the first outlet to the third channel and third outlet and configured to direct the stream to the second chromatographic column. In a second operational mode of the FRPM assembly, the first flow control valve and the second flow control valve are open to direct the stream through the second channel and the second outlet and configured to direct the stream to the bypass line. Auxiliary fluid from the auxiliary flow conduit flows through the first flow resistor component and minimizes or prevents fluid from flowing through the first channel and first outlet towards the second chromatographic column and the first flow resistor component minimizes any disturbances caused by the auxiliary fluid flow in the stream in the first chromatographic column.

In one aspect, the at least one flow control valve comprises a three-way valve.

In certain aspects the present disclosure also relates to a multidimensional gas chromatography device. The multidimensional gas chromatography device comprises a first chromatographic column that receives a fluid sample comprising one or more target analytes. The multidimensional gas chromatography device also comprises a flow-restricted pneumatic modulator (FRPM) assembly disposed downstream of and in fluid communication with the first chromatographic column, where the FRPM assembly receives a stream from the first chromatographic column. The FRPM assembly comprises: a first y-shaped fluid connector having a first inlet, a first channel having a first outlet, and a second channel having a second outlet, a first flow resistor component disposed in the first channel having a first flow resistance to the stream, where the second channel has a second flow resistance to the stream that is less than the first flow resistance, and a second y-shaped fluid connector. The second y-shaped fluid connector has a second inlet, a third inlet, and a third channel having a third outlet. The second inlet is in fluid communication with the first outlet of the first y-shaped connector and receives the stream from the first chromatographic column. The FRPM assembly also includes at least one flow control valve. The multidimensional gas chromatography device further comprises an auxiliary fluid conduit disposed upstream of the FRPM assembly. The third inlet of the second y-shaped fluid connector is in fluid communication with the auxiliary fluid conduit. The multidimensional gas chromatography device also comprises a second chromatographic column disposed downstream of the FRPM assembly and in fluid communication with the third outlet of the second y-shaped fluid connector. The FRPM assembly is configured to be operated as an injector and a modulator to the second chromatographic column. A bypass line is disposed downstream of the FRPM assembly and in fluid communication with the second outlet of the first y-shaped fluid connector. At least one flow control valve controls flow of the stream to the bypass line. The multidimensional gas chromatography device also comprises at least one detector for detecting a presence of the one or more target analytes eluted from the stream after passing through the second chromatographic column.

In one aspect, the at least one flow control valve is a second flow control valve in fluid communication with the second outlet of the first y-shaped fluid connector. The multidimensional gas chromatography device further comprises a first flow control valve disposed upstream of the FRPM assembly in fluid communication with the third outlet of the second y-shaped fluid connector.

In one further aspect, the first flow control valve and the second flow control valve are respectively two-port valves each having an open position and a closed position.

In one further aspect, in a first operational mode of the FRPM assembly, the first flow control valve and the second flow control valve are closed to direct the stream through the first channel, the first flow resistor component, the first outlet, the second inlet, and through the third channel to the third outlet to direct the stream to the second chromatographic column. In a second operational mode of the FRPM assembly, the first flow control valve and the second flow control valve are open to direct the stream through the second channel and the second outlet and configured to direct the stream to the bypass line and the first flow resistor component minimizes or prevents fluid from flowing through the first channel and first outlet towards the second chromatographic column.

In one aspect, the at least one flow control valve comprises a three-way valve.

In one aspect, the FRPM assembly further comprises a second flow resistor component disposed in the second channel of the first y-shaped fluid connector, the second flow resistor component having the second flow resistance that is less than the first flow resistance.

In one aspect, the FRPM assembly is formed in the substrate.

In one further aspect, wherein the substrate further comprises (i) the first chromatographic column upstream of the FRPM assembly, (ii) the second chromatographic column downstream of the FRPM assembly, or (iii) the first chromatographic column upstream of the FRPM assembly and the second chromatographic column downstream of the FRPM assembly.

In one aspect, the at least one detector comprises a photoionization detector (PID).

In one aspect, the multidimensional gas chromatography device further comprises a second detector disposed downstream of the first chromatographic column and upstream of the first inlet of the FRPM assembly.

In one aspect, the first chromatographic column is a first micro-gas chromatographic column and the second chromatographic column is a second micro-gas chromatographic column, wherein the multidimensional gas chromatography device is portable.

In certain aspects the present disclosure also relates to a method of chromatographic analysis of a fluid sample comprising one or more target analytes in a multidimensional chromatography system. The method comprises separating the one or more target analytes in the fluid sample in a first chromatographic column and directing a stream exiting the first chromatographic column toward a flow-restricted pneumatic modulator (FRPM) assembly that operates as an injector and a modulator to a downstream second chromatographic column. The FRPM assembly comprises a first y-shaped fluid connector having a first inlet, a first channel having a first outlet, and a second channel having a second outlet. The first y-shaped fluid connector also has a first flow resistor component disposed in the first channel having a first flow resistance to the stream. The second channel has a second flow resistance to the stream that is less than the first flow resistance. The FRPM assembly also comprises a second y-shaped fluid connector having a second inlet, a third inlet, and a third channel having a third outlet. The second inlet is in fluid communication with the first outlet of the first y-shaped connector and receives the stream from the first chromatographic column. The FRPM assembly also includes at least one flow control valve. The method further comprises operating the FRPM assembly in a first operational mode for a first duration where the at least one flow control valve is closed to selectively direct the stream through the first channel, through the first flow resistor component, through the first outlet to the second inlet through the third channel and third outlet to a second chromatographic column. The method also comprises operating the FRPM assembly in a second operational mode for a second duration where the at least one flow control valve is open to direct the stream through the second channel and the second outlet and to a downstream bypass line.

In one aspect, the at least one flow control valve comprises a first flow control valve in fluid communication with the second outlet of the first y-shaped fluid connector upstream of the bypass line and a second flow control valve in fluid communication with the third inlet of the second y-shaped fluid connector. The first flow control valve and the second flow control valve are respectively two-port valves each having an opened position and a closed position.

In one aspect, the first duration is less than or equal to about 0.2 seconds.

In one aspect, in the first operational mode, the second chromatographic column has a peak injection width of less than or equal to about 25 milliseconds.

In one aspect, a first flow rate of the stream in the first operational mode is less than or equal to about 0.5 mL/minute and a flow rate of the stream in the second operational mode is greater than or equal to about 1 mL/minute.

In one aspect, the multidimensional chromatography system further comprises an auxiliary fluid conduit upstream of the FRPM assembly. The at least one flow control valve comprise a first flow control valve and a second flow control valve that is configured to receive auxiliary fluid from the auxiliary fluid conduit upstream of the third inlet of the second y-shaped fluid connector. The auxiliary fluid conduit is in fluid communication with the second chromatographic column, so that in the second operational mode, the auxiliary fluid flows through the first flow resistor component and minimizes or prevents fluid from flowing through the first channel and first outlet towards the second chromatographic column and the first flow resistor component minimizes any disturbances caused by the auxiliary fluid flow in the stream in the first chromatographic column.

In one aspect, the stream entering the second chromatographic column during the first operational mode has a first flow rate and the auxiliary fluid entering the second chromatographic column during the second operational mode has a second flow rate. A ratio of the second flow rate to the first flow rate is greater than or equal to about 10:1.

In one aspect, the method further comprises repeating the operating the FRPM assembly in the first operational mode for the first duration and the operating the FRPM assembly in the second operational mode for the second duration.

In one aspect, the FRPM assembly has a duty cycle of greater than or equal to about 1% to less than or equal to about 50%.

In one aspect, the method further comprises detecting one or more target analytes in a secondary stream exiting the second chromatographic column.

In one aspect, the method further comprises detecting one or more target analytes in the stream exiting the first chromatographic column.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an example of a multidimensional gas chromatography system having a flow-restricted pneumatic modulator (FRPM) assembly prepared in accordance with certain aspects of the present disclosure, where the FRPM assembly can be used as an injector and a modulator.

FIG. 2 shows a specific example of a multidimensional gas chromatography system having an FRPM assembly prepared in accordance with certain aspects of the present disclosure.

FIGS. 3A-3D show chromatograms obtained with the setup and multidimensional gas chromatography system parameters given in FIG. 2. Two traces (black (Detector 1) and red (Detector 2)) in each sub-figure represent the data acquired by Detector 1 and Detector 2, respectively. The modulation time is 2 seconds with the loading time or cut time varies from 0.1 s to 0.4 s.

FIGS. 4A-4D show a flow-restricted pneumatic modulator (FRPM) prepared in accordance with certain aspects of the present disclosure used in operation of comprehensive 2D μGC. FIG. 4A shows ¹D to ²D loading configuration with both valves closed (typical flow rate: ~1 mL/min). The blue arrows depict the ¹D flow direction. FIG. 4B shows ²D separation with both valves open for high ²D flow (typical flow rate: ~10 mL/min), enabling sharp ²D injection and rapid ²D separation. The green arrows depict the auxiliary flow direction. FIG. 4C shows a microfabricated FRPM schematic and depiction. The flow resistor is a narrow channel with a cross section of 40 μm×170 μm (width×depth) and a length of 2 mm. All other channels had cross sections of 250 μm×250 μm (width×depth). FIG. 4D shows the FRPM module with FRPM and two 2-port valves. Ports 1-4 are labelled on the schematics and in depictions.

FIGS. 5A-5D. FIG. 5A is a schematic of a setup used to characterize a FRPM module prepared in accordance with certain aspects of the present disclosure. A sample mixture was injected into a 10 m OV-1 coated microcolumn (μcolumn) with cross sections of 200 μm×250 μm (width×depth). A microphotoionization detector (¹D μPID) was connected to the ¹D μcolumn and monitored the ¹D eluents. The ²D μPID was connected to the outlet of the FRPM module via a 20 cm guard column (inner diameter: 250 μm) and monitored the ²D eluents. Ports 1-4 labelled on the FRPM module are described in FIG. 1. Unmodulated operation is shown in FIG. 13A. FIG. 5B shows ¹D and ²D chromatograms of C₆, C₇, C₈, benzene, and toluene. The time-tags (shown as blue square wave) record the closed (═O) and open (=1) states of the FRPM module valves, corresponding to ²D loading (═O) and ²D separation (=1), respectively. FIG. 5C is a magnified view of C₇ in ¹D and ²D. FIG. 5D is a magnified view of C₇ in ²D. Experimental conditions: loading time=0.25 s; modulation time=2 s; ¹D flow rate=1.2 mL/min (measured at Port 3 with both valves closed). The flow rate was nearly the same when measured at the outlet of ¹D (before the FRPM), indicating that the impact of the flow resistor on the ¹D flow is negligible. ²D flow rate=20 mL/min (measured at Port 3 with both valves open). The ¹D μcolumn temperature ramping profile is provided in FIG. 13B. The FRPM was kept at isothermal ambient temperature (approximately 20° C.). Helium was used as both ¹D carrier gas and auxiliary flow.

FIGS. 6A-6D show ²D peak widths (full width at half maximum) of C₆, C₇, and C₈ detected by ²D μPID vs. ²D/¹D flow rate ratio (FIG. 6A) and loading time (FIG. 6C). The ideal ²D peak width is calculated by the loading time divided by the flow rate ratio. Deviations of ²D peak widths from ideal injection widths vs. flow rate ratio (FIG. 6B) and loading time (FIG. 6D). In FIGS. 6A and 6B, the loading time was fixed at 0.25 s and the ²D flow rate varied from 4 to 40 mL/min. In FIGS. 6C and 6D, the ²D flow rate was fixed at 16 mL/min and the loading time varied from 0.1 to 0.5 s. In all experiments, ¹D flow rate=1.2 mL/min and modulation time=2 s. Error bars are obtained with 3 measurements.

FIGS. 7A-7E. FIG. 7A shows a schematic of an FRPM prepared in accordance with certain aspects of the present disclosure integrated with 0.5 m ²D μcolumn (microcolumn). FIG. 7B shows a depiction based on a photograph of an integrated FRPM chip (top) with backside heater (bottom). FIG. 7C shows ¹D and ²D chromatograms of C₆, C₇, C₈, benzene, and toluene using deactivated integrated FRPM chip. FIG. 7D shows a magnified view of C₇ in ¹D and ²D. FIG. 7E shows a magnified view of C₇ in ²D. Experimental conditions: loading time=0.25 s; modulation time=2 s; ¹D flow rate=1.1 mL/min; ²D flow rate=14 mL/min. The ¹D temperature ramping profile was the same as in FIG. 2. The integrated chip was at isothermal room temperature (~20° C.). Helium was used as both ¹D carrier gas and auxiliary flow.

FIGS. 8A-8B. FIG. 8A shows a schematic of an integrated FRPM-based portable comprehensive 2D μGC device prepared in accordance with certain aspects of the present disclosure. The integrated FRPM module contains a 0.5 m long WAX ²D μcolumn. FIG. 8B shows depictions of the system based on photographs. The device has dimensions 28 cm×23 cm×13 cm (length×width×height) and weighs 2.4 kg (including helium cartridge). The reference numbers are as follows: 1. Integrated FRPM and 0.5 m WAX ²D μcolumn module (within the dashed square); 2. ¹D 10 m OV-1 μcolumn; 3. Preconcentrator. 4. μPID array; 5. Printed circuit board and data acquisition card (copper mesh shielded); 6. Pump; 7. 3-port valve; 8. 2-port valve; 9. DC-DC converter; 10. 24 V power supply; 11. Rocker switch connected to wall power.

FIGS. 9A-9J. FIG. 9A shows ¹D and ²D chromatograms of 40 VOC mix obtained by ¹D and ²D μPIDs in the portable comprehensive 2D μGC device. FIGS. 9B-9C show magnified areas from of area #1 of FIG. 9A. FIGS. 9D-9E show area #2 in ¹D and ²D from FIG. 9A. FIG. 9F shows a 2D contour plot using the new method that relies on both ¹D and ²D chromatograms in FIG. 9A. Magnification of peaks 13-16 (FIG. 9G), 31-32 (FIG. 9H), 26-28 (FIG. 9I) and 36 (FIG. 9J). FIGS. 9H and 9J correspond to FIGS. 9C and 9E, respectively. For comparison, the 2D contour plot using the conventional method that relies only on the ²D microPID data is presented in FIGS. 28A-28C. Experimental conditions: ¹D flow rate=1.2 mL/min; ²D flow rate=11 mL/min. Loading time=0.4 s; modulation was segmented into three periods: modulation time=1 s from 0 to 75 s; 2 s from 75 to 180 s; and 4 s from 180 to 350 s. Both ¹D μcolumn (OV-1) and ²D integrated FRPM module underwent temperature ramping (FIGS. 13B and 26A-26D). Helium was used as both ¹D carrier gas and auxiliary flow.

FIGS. 10A-10F shows a method for making an FRPM in accordance with certain aspects of the present disclosure, which includes an integrated version that has a 2D column and μcolumn microfabrication process. In FIG. 10A, a soft mask of photoresist exposes both column and inlets/outlets. FIG. 10B shows creation of an oxide hard mask through DRIE (deep-reactive-ion-etching). FIG. 10C shows a soft mask exposing only inlets/outlets for DRIE to 150 μm. FIG. 10D shows DRIE applied on the entire pattern area to etch inlets/outlets to 400 μm and column to 250 μm. FIG. 10E shows BHF (buffered hydrofluoric acid) stripping off oxide mask and anodic bonding with Pyrex glass to seal the column. FIG. 10F shows a patterned metal heater (30 nm Titanium/320 nm Platinum) deposition on the backside.

FIGS. 11A-11B show a coating procedure for the integrated FRPM with a ²D μcolumn. FIG. 11A shows Step I: Hexamethyldisilane (HMDS) deactivation of all microfluidic channels. FIG. 11B shows Step II: ²D μcolumn coating. A dummy 10 m μcolumn was used for coating flow control. Only select channels were coated. After coating, the coating outlet was sealed by epoxy.

FIGS. 12A-12D show velocity field distribution of an FRPM during ²D loading and separation phases in a comparative FRPM without (FIGS. 12A, 12C) and with (FIGS. 12B, 12D) a flow resistor prepared in accordance with certain aspects of the present disclosure.

FIGS. 13A-13B show the unmodulated operation for the system depicted in FIG. 2. FIG. 13A shows unmodulated operation for calibration of ¹D and ²D μPIDs using the setup in FIG. 2A. ¹D=²D=1.2 mL/min flow rate. It shows that the ²D μPID was 2.4 times more sensitive than ²D μPID. FIG. 13B shows temperature ramping profile of the ¹D 10 m OV-1 coated micro-column.

FIGS. 14A-14C show ¹D peak delays of C₆, C₇, and C₈ detected by ¹D μPID versus flow rate ratio (FIG. 14A), loading time (FIG. 14B), and modulation time (FIG. 14C).

FIGS. 15A-15D. Magnified ¹D and ²D chromatograms of C₇ using the FRPM module. ²D flow rate=14 mL/min (FIG. 15A), 25 mL/min (FIG. 15B), 30.5 mL/min (FIG. 15C), and 37 mL/min (FIG. 15D). For all experiments, ¹D flow rate=1.2 mL/min, loading time=0.25 s, and modulation time=2 s. Black arrows indicate the jittering in a ¹D peak.

FIGS. 16A-16D. FIG. 16A shows a schematic of a microfabricated pneumatic modulator without the 40 μm wide flow resistor. The flow resistor region has the same cross section of 250 μm×250 μm (width×depth) as all other channels. FIGS. 16B-16D show a magnified view of ¹D and ²D chromatograms of C₇. ²D flow rate=6 mL/min (FIG. 16B), 11 mL/min (FIG. 16C), and 20 mL/min (FIG. 16D). For all experiments, ¹D flow rate=1.2 mL/min, loading time=0.25 s, and modulation time=2 s. Black arrows indicate the jittering in a ¹D peak.

FIGS. 17A-17C. FIG. 17A shows a calculated retention time delay as a function of α. FIG. 17B shows a retention time delay as a function of loading time. α=0.8, modulation time=2. FIG. 17C shows a retention time delay as a function of modulation time. α=0.8, loading time=0.25 s. In all calculations, L=10 m and V₀=0.1 m/s.

FIGS. 18A-18E show magnified ¹D and ²D chromatograms of C₇ using the FRPM module. Loading time=0.1 s (FIG. 18A), 0.2 s (FIG. 18B), 0.3 s (FIG. 18C), 0.4 s (FIG. 18D), and 0.5 s (FIG. 18E). For all experiments, modulation time=1 s, ¹D flow rate=1.2 mL/min, and ²D flow rate=16 mL/min.

FIGS. 19A-19B. FIG. 19A shows a peak area ratio of between C₇ peaks in ²D and ¹D extracted from FIGS. 18A-18E. FIG. 19B shows a peak area ratio normalized by the loading time extracted from FIG. 19A. Error bars are obtained with 3 measurements.

FIGS. 20A-20G show magnified ¹D and ²D chromatograms of C₇ operated without flow resistor with a loading time=0.025 s (FIG. 20A), 0.05 s (FIG. 20B), 0.1 s (FIG. 20C), 0.2 s (FIG. 20D), 0.3 s (FIG. 20E), 0.4 s (FIG. 20F), and 0.5 s (FIG. 20G). For all experiments, modulation time=1 s, ¹D flow rate=1.3 mL/min, and ²D flow rate=7.5 mL/min. Black arrows indicate the jittering features in ¹D peak.

FIGS. 21A-21B. FIG. 21A shows a peak area ratio of between C₇ peaks in ²D and ¹D extracted from FIGS. 20A-20G. FIG. 21B shows a peak area ratio normalized by the loading time extracted from (FIG. 21A). Error bars are obtained with 3 measurements.

FIGS. 22A-22D show an alternative FRPM prepared in accordance with certain aspects of the present disclosure having a single-valve based operating principle for comprehensive 2D μGC. FIG. 22A shows ¹D to ²D loading configuration with the normally-open (NO) port open in the 3-port valve (typical ¹D flow rate: ~1 mL/min). C=common; NC=normally-closed. The flow resistor (labelled orange) is a 1.2 m long guard column. The blue and green arrows depict the ¹D and auxiliary flow directions, respectively. FIG. 22B shows ²D separation with the NC port open for a high ²D flow (typical flow rate: ~10 mL/min), enabling sharp ²D injection and rapid ²D separation. FIG. 22C shows a single-valve FRPM schematic. It has an additional Port 5 compared to FRPM embodiment shown in FIG. 1. FIG. 22D shows a depiction based on a photograph of the single-valve FRPM module with a 3-port valve.

FIGS. 23A-23D. FIG. 23A shows a setup used to characterize the single-valve FRPM module (identical to the one in FIG. 5A). FIG. 23B shows ¹D and ²D chromatograms of C₆, C₇, C₈, benzene, and toluene. FIG. 23C is a magnified view of C₇ in ¹D and ²D. FIG. 23D is a magnified view of C₇ in ²D. Experimental conditions: loading time=0.25 s, modulation time=2 s, ¹D flow rate=1.4 mL/min, and ²D flow rate=18.5 mL/min. The ¹D flow rate was calibrated at the end of the ¹D μPID before connecting to the single-valve FRPM module. The ²D flow rate was calibrated at the end of the ²D μPID after connecting the single-valve FRPM module and switching the 3-port valve to the normally closed port. The ¹D μcolumn underwent temperature ramping (see FIG. 13B). The single-valve FRPM was at room temperature (about 20° C.). Helium was used as both ¹D carrier gas and auxiliary flow. Note that an external flow resistor (1.2 m guard column) was used to restrict the buffer flow rate during loading but can in principle be microfabricated on the same chip for compactness.

FIGS. 24A-24C. FIG. 24A shows ²D peak widths; FIG. 24B shows deviations of ²D peak widths from ideal injection widths; and FIG. 24C shows ¹D peak delay of C₆, C₇, and C₈ versus flow rate ratio of the single-valve FRPM module-based system. Experimental conditions: ²D flow rate=3 to 44 mL/min, ¹D flow rate=1.4 mL/min, loading time=0.25 s, and modulation time=2 s for all experiments. Error bars are obtained with 3 measurements.

FIGS. 25A-25C. FIG. 25A shows ²D peak widths extracted from FIG. 7C. FIG. 25B shows deviations of ²D peak widths from ideal ²D injection widths. FIG. 25C shows ¹D peak delay of C₆, C₇, and C₈ versus flow rate ratio of the integrated FRPM module based system. Experimental conditions: ¹D flow rate=1.1 mL/min, ²D flow rate=3.6 to 31 mL/min, loading time=0.25 s, and modulation time=2 s for all experiments. Error bars are obtained with 3 measurements.

FIGS. 26A-26D are magnified ¹D and ²D chromatograms of C₇ using the FRPM module based portable comprehensive ²D μGC prepared according to certain aspects of the present disclosure with ²D flow rate=9 mL/min (FIG. 26A), 14 mL/min (FIG. 26B), 20 mL/min (FIG. 26C), and 25 mL/min (FIG. 26D). For all experiments ¹D flow rate=1.1 mL/min, loading time=0.25 s, and modulation time=2 s. Black arrows indicate the jittering features in a ¹D peak when the ²D flow rate is above 20 mL/min.

FIG. 27 shows temperature ramping profile of the integrated FRPM chip prepared according to certain aspects of the present disclosure. The ²D column has the same temperature ramping profile.

FIGS. 28A-28C. FIG. 28A shows ²D counter plot generated using only the ²D chromatogram in FIG. 6(A). FIGS. 28B and 28C correspond to the magnified areas of FIGS. 9G and 9I, respectively. Note that only 32 peaks were counted from the 2D contour plot in (FIG. 28A) versus 40 peaks from the 2D contour plot in FIG. 9F.

FIG. 29 shows a magnified view of C₉ from FIG. 9A. Red arrows indicate separations in ²D implying co-elution in ¹D.

FIGS. 30A-30D. FIG. 30A shows a schematic of the FRPM based comprehensive ²D μGC device prepared in accordance with certain aspects of the present disclosure operated in a stop-flow modulation mode, in which Port 4 is permanently blocked. When the 2-port valve is closed, ¹D separation takes place and the eluents from the ¹D column are loaded to the ²D column. When the 2-port valve is open, ¹D separation is suspended and the helium source generates a high ²D flow for rapid ²D separation. FIG. 30B shows ¹D and ²D chromatograms of 40 VOCs generated by stop-flow modulation. Inlet shows the ²D separation of 2 VOCs. The entire separation is completed in ~600 s, much longer than 300 s reported in FIG. 9A. FIG. 30C shows a magnified portion of FIG. 30B, where strong jittering in the ¹D chromatogram can be seen easily. FIG. 30D shows unmodulated operation when the 2-port valve is permanently closed. Experimental conditions: ¹D flow rate=1.2 mL/min, ²D flow rate=11 mL/min, loading time=0.4 s, and modulation time=2 s. Unmodulated: ¹D flow rate=²D flow rate=1.2 mL/min. Both ¹D μcolumn and ²D integrated FRPM module underwent temperature ramping shown in FIGS. 13B and 27, respectively.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides a flow-restricted pneumatic modulator (FRPM) assembly for a multidimensional gas chromatography system. Such a FRPM assembly may be a microfabricated chip-based FRPM that enables sharp injection into a second-dimensional (²D) column of a multidimensional gas chromatography system and high second-dimensional (²D) column flow rates without suspending first-dimensional (¹D) column separation during operation. In the FRPM assembly provided, a new type of pneumatic modulator, is provided to cut the eluents from the first-dimensional column and then inject them into the second-dimensional column. In certain aspects, the multidimensional gas chromatography system has a first chromatographic column is a first micro-gas chromatographic column and the second chromatographic column is a second micro-gas chromatographic column, wherein the multidimensional gas chromatography device is portable. The term “microfluidic channel” can include one or more fluid flow paths having dimensions of tens to hundreds of micrometers. As used herein, the term “fluid” is intended to broadly encompass gases, liquids, vapors, semi-liquids, and suspensions of solids in liquids or gases.

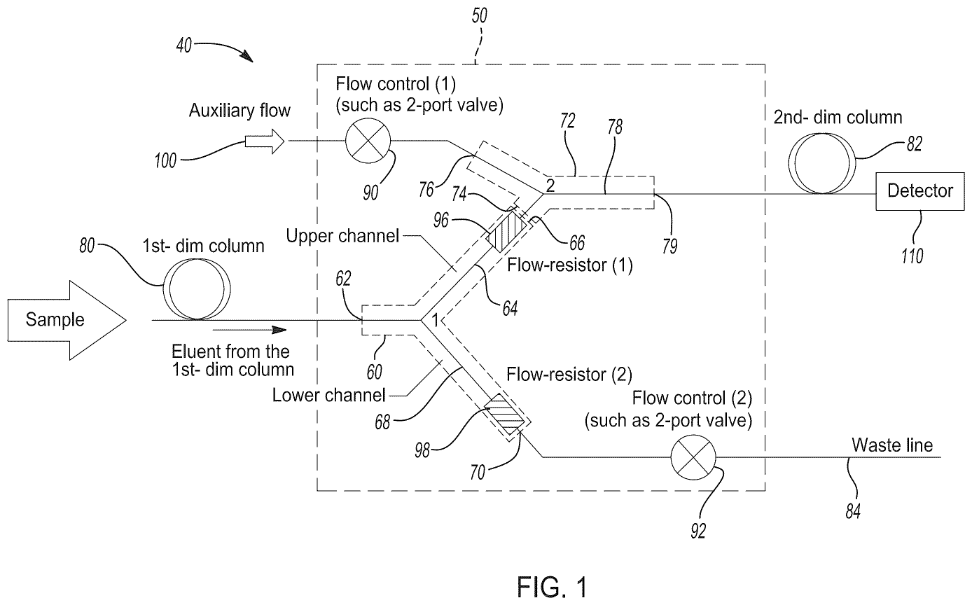

A multidimensional gas chromatography system 40 shown in FIG. 1 includes a FRPM assembly or more particularly a flow-restricted pneumatic modulator flow-restricted pneumatic modulator (FRPM) assembly 50 delineated by the dashed box. The FRPM assembly 50 includes a first y-shaped fluid connector 60 generally delineated by a dashed line and having an inlet 62, a first channel 64 having a first outlet 66, and a second channel 68 having a second outlet 70, all in fluid communication with one another. The inlet 62 is configured to connect to a first chromatographic column 80 upstream of the FRPM assembly 50 and is thus in fluid communication with the first chromatographic column 80. The first chromatographic column 80 receives a sample fluid that comprises one or more target analytes to be analyzed and detected in the multidimensional gas chromatography system 40. The second outlet 70 is configured to connect to a downstream waste or bypass line 84.

Thus, in this variation, the FRPM assembly 50 may comprise a 1×2 first y-shaped connector 60 that connects the first-dimensional column 80 and two downstream first and second channels 64, 68 (marked as “upper channel” and “lower channel”, respectively, in FIG. 1) and two flow controls 90, 92 (such as 2-port valves that can be open and closed). The FRPM assembly 50 also includes a second y-shaped fluid connector 72 generally delineated by a dashed line, as will be described further below.

The FRPM assembly 50 also includes a first flow resistor component 96 disposed in the first or upper channel 64 of the y-connector 60. The first flow resistor component 96 may be a short channel or column, but having a much smaller cross section than other fluidic channels in the FRPM assembly 50. The second or lower channel 68 may have a second flow resistance to the stream that is less than the first flow resistance associated with the first flow resistor component 96. In certain variations, the FRPM assembly 50 may also optionally include a second flow resistor component 98, “flow resistor 2,” which is disposed in the second or lower channel 68. The flow resistance of “flow resistor 1” 96 is much larger than that of “flow resistor 2” 98 and thus provides the flow-restricted pneumatic modulator 50 with asymmetrical flow resistance.

The FRPM assembly 50 also includes a second y-shaped fluid connector 72 generally delineated by a dashed line and having a second inlet 74, a third inlet 76, a third channel 78 and a third outlet 79, all in fluid communication with one another. The second y-shaped fluid connector 72 thus in positioned in an opposite orientation to the first y-shaped fluid connector 60, so that the first y-shaped fluid connector 60 has a single inlet (first inlet 62) and two outlets (first outlet 66 and second outlet 70), as where the second y-shaped fluid connector 72 has two inlets (second inlet 74 and third inlet 76) and a single outlet (third outlet 79) in the direction of flow of the stream coming from the first chromatographic column 80 and headed towards the second chromatographic column 82 or bypass line 84. The first outlet 66 of the first y-shaped fluid connector 60 is thus connected to and in fluid communication with the second inlet 74 of the second y-shaped fluid connector 72. Thus, the second inlet 74 is in fluid communication with the first outlet 66 of the first y-shaped connector 60 and configured to receive the stream from the first chromatographic column 80.

The multidimensional gas chromatography system 40 may also include an auxiliary flow conduit 100 upstream of the FRPM assembly 50 that receives an inert carrier gas/auxiliary fluid. The third inlet 76 is configured to be in fluid communication with the auxiliary flow conduit 100, so that auxiliary fluid may pass through the second y-shaped fluid connector 72. Any fluid streams passing through the second y-shaped fluid connector 72 exit through the third channel 78 and third outlet 79 and are directed towards the second chromatographic column 82.

The FRPM assembly 50 includes at least one flow control valve. For example, the FRPM assembly 50 in FIG. 1 has a first flow control valve 90 upstream of the second inlet 76 of the second y-shaped fluid connector 72 that controls auxiliary fluid flow into the second y-shaped fluid connector 72. A second flow control valve 92 is also included that is in fluid communication with the second outlet 70 of the first y-shaped fluid connector 60 and thus upstream of the second chromatographic column 82. In certain variations, the first flow control valve 90 and the second flow control valve 92 are respectively two-port valves each having an open position and a closed position. As will be described further herein, the FRPM assembly 50 is configured to be operated as an injector and a modulator to the second chromatographic column 82.

The second chromatographic column 82 comprises a detector 110 for detecting one or more target analytes processed within the second chromatographic column 82. While not shown in FIG. 1, other detectors may be included in the system, including downstream of the first dimensional chromatographic column 80 to detect analytes eluted therefrom.

The detectors may be photoionization detectors (PIDs), such as micro-photoionization detectors (μPID). In certain variations, the detector may be a non-destructive on-column detector, such as a capillary based optical ring resonator (CBORR) device, a Fabry-Pérot interferometer based sensor, a chemi-resistor sensor, a sound acoustic wave sensor, a thermal conductivity sensor, and the like.

Additionally, the multidimensional gas chromatography system 40 may have additional components known in the art, but not shown, including preconcentrators, additional columns, seals, valves, monitors (e.g., pressure and temperature monitors), connectors, electrical wiring, gaskets, controllers, and the like.

In certain aspects, the disclosure contemplates the FRPM assembly and/or portions of the multidimensional gas chromatography device being formed in a substrate, such as a chip, board, or base platform. The substrate may be inorganic or organic, such as silicon dioxide, silicon, glass, polymers, and the like by way of non-limiting example. In certain variations, a multidimensional gas chromatography device includes the substrate having the FRPM assembly formed therein and one of the following configurations: (i) the first chromatographic column upstream of the FRPM assembly; (ii) the second chromatographic column downstream of the FRPM assembly; or (iii) the first chromatographic column upstream of the FRPM assembly and the second chromatographic column downstream of the FRPM assembly. In this manner, the FRPM and chromatographic columns may be microfluidic structures and the multidimensional gas chromatography may be portable.

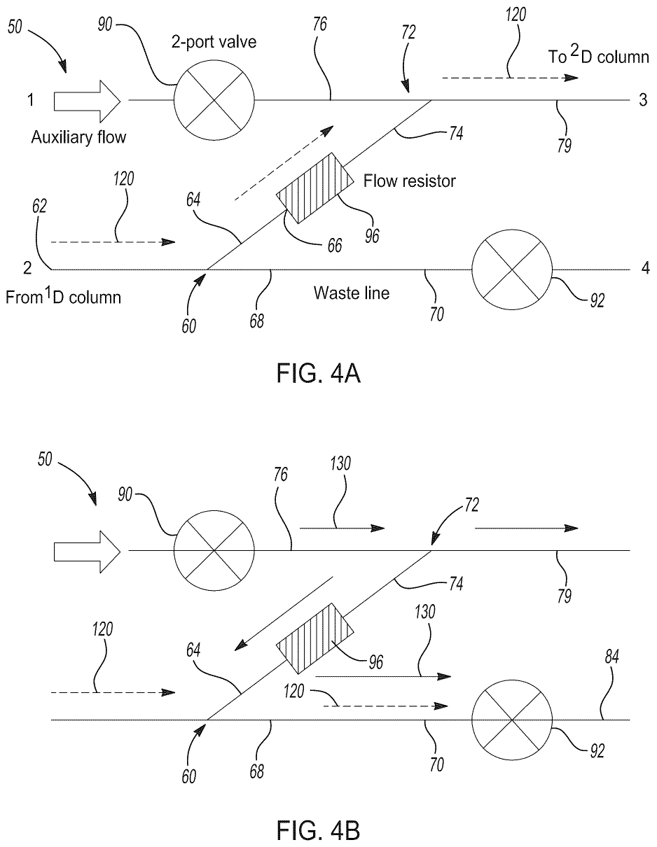

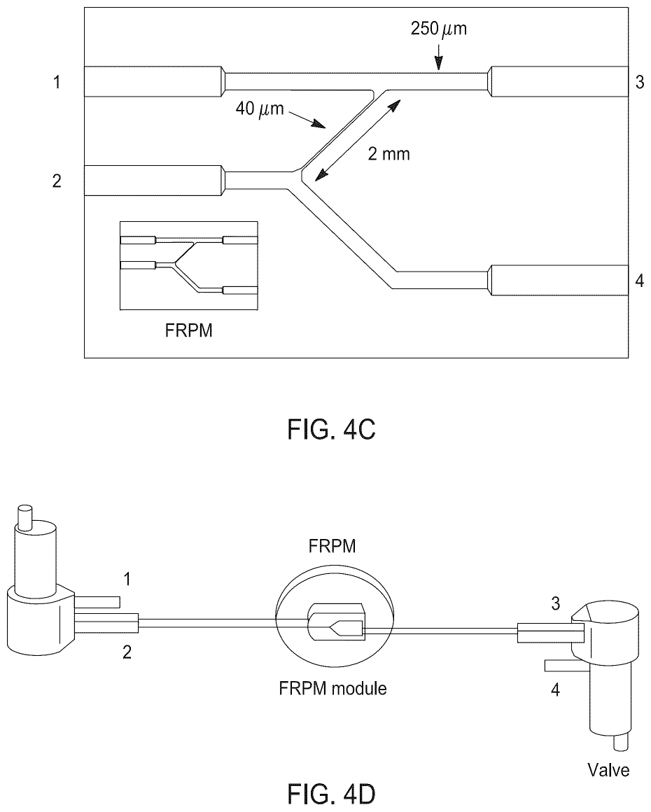

As best seen in FIGS. 4A-4B, the flow-restricted pneumatic modulator (FRPM) assembly 50 may have a first operational mode shown in FIG. 4A where both the first fluid flow control valve 90 and the second fluid flow control valve 92 are closed. When the first and second flow control valves 90, 92 are closed, a fluid sample/stream 120 eluted from the upstream first chromatographic column (80 shown in FIG. 1) is directed through the first channel 64 and first outlet 66 and through the first flow resistor component 96 of the first y-shaped fluid connector 60 and into the second inlet 74 of the second y-shaped fluid connector 72 and out the third outlet 79. The fluid sample 120 is thus directed to the second chromatographic column (82 shown in FIG. 1) in the first operational mode.

As shown in FIG. 4B, the flow-restricted pneumatic modulator (FRPM) assembly 50 also has a second operational mode, where the first fluid flow control valve 90 and the second fluid flow control valve 92 are open to direct the fluid sample 120 eluted from the upstream first chromatographic column (80 shown in FIG. 1) through the second channel 68 and the second outlet 70 of the first y-shaped fluid connector 60. In this second operational mode, the fluid sample 120 is directed to the waste or bypass line 84.

As shown in FIG. 4B, auxiliary fluid 130 (e.g., carrier gas) originates from the auxiliary fluid conduit (100 shown in FIG. 1) upstream of the FRPM assembly 50, where the first flow control valve 90 is configured to receive the auxiliary fluid 130. The auxiliary fluid 130 flows both to the secondary chromatographic column (82 in FIG. 1) and through the first flow resistor component 96, first channel 64, through the second channel 68, and exits the first outlet 70, where auxiliary fluid 130 then passes on through the open second control valve 92 to the bypass line 84. As such, the part of auxiliary flow 130 that travels through the first channel 64 minimizes or prevents the fluid stream 120 from flowing through the first channel 64 and thus back through the second y-shaped fluid connector 72 to the downstream second chromatographic column (82 shown in FIG. 1) in a second operational mode. Thus, the first flow resistor component 96 serves to minimize or prevent the fluid sample 120 from traveling in a direction towards the second y-shaped fluid connector 72 (and thus into downstream second chromatographic column 82 in FIG. 1) by using a very small amount of downward auxiliary fluid 130 flow, in other words, the first flow resistor component 96 minimizes or prevents too much auxiliary fluid 130 from flowing downward towards the first channel 64. If the auxiliary fluid 130 flow toward the first channel 64 were not minimized, otherwise the flow and separation processing in the first-dimensional chromatographic column 80 would undesirably be disturbed or perturbed. In the second operational mode, a portion of the auxiliary fluid 130 thus flows into the second dimensional column, inter alia.

Thus, in the first operational mode of the flow-restricted pneumatic modulator 50, when both the first and second flow control valves 90, 92 are closed, the flow and the eluent from the first-dimensional column are diverted to the first or upper channel 64 and then into the second-dimensional column. This fluid stream/flow experiences a high flow resistance with a total resistance including that from the first-dimensional column, plus resistance from the first flow resistor 96, and resistance from the second dimensional column. Consequently, the flow rate to load eluent (fluid sample 120) from the first-dimensional column to the second-dimensional column is low.

However, in the second operational mode, where both the first and second flow control valves 90, 92 are open, there are two effects. First, the flow from the first-dimensional column is diverted to the second or lower channel 68 of the y-shaped fluid connector 60, because the auxiliary fluid flow 130 goes downward through the first or upper channel 64 and prevents the first-dimensional flow 120 and the eluents/fluid sample 120 from going to the upper or first channel 64. Second, the flow in the first-dimensional column experiences a low flow resistance, with a total resistance that is contributed to only from the first-dimensional column and an optional second flow resistor component (shown as second flow resistor component 98 in FIG. 1, but not shown in FIGS. 4A-4B). Consequently, the flow rate in the first-dimensional column becomes higher.

Based on the operational principles discussed above, a comprehensive ²D GC that incorporates a flow-restricted pneumatic modulator (FRPM) assembly in accordance with certain aspects of the present disclosure can be operated as follows. In the first operational mode, both the first and second flow control valves 90, 92 are closed for a first duration, also referred to as a loading time, which may be a short amount of time. In certain aspects, the first duration is less than or equal to about 0.2 seconds, although other first durations are contemplated below. Then, in the second operational mode, both the first and second flow control valves 90, 92 are switched to open for a second duration of time. The second duration of time in the second operational mode is greater than the first duration of time in the first operational mode. The time or duration when both valves are open is a second duration, called a second dimensional separation time.

In this second operational mode, as described above, the flow and the eluents from the first-dimensional column go to the lower second channel 68 of the first y-shaped fluid connector 60. This allows the separation of the analytes in the first-dimensional column to take place at a high flow rate (for example, at about 1 to about 2 mL/min volumetric flow rate). Meanwhile, the high auxiliary fluid flows serves as the carrier gas for the second-dimensional column separation at a very high flow rate (for example, about 5 mL/min). A higher carrier gas flow rate makes the injected peak sharper in the second-dimensional column. The peak width squeezing ratio is determined approximately by the carrier gas flow rate and the loading flow rate for the second-dimensional column, as described further below.

The summation of the first duration (loading time) and second duration (separation time) is modulation time. In one example, a first duration or loading time may be about 0.2 seconds and a second duration or separation time may be about 1.8 seconds, for example. Then, the modulation time is 2 seconds. In certain aspects, a modulation or total operating time may be greater than or equal to about 0.005 seconds to less than or equal to about 50 seconds, optionally greater than or equal to about 0.2 seconds to less than or equal to about 50 seconds, and optionally greater than or equal to about 0.2 seconds to less than or equal to about 20 seconds. The operation sequences may optionally be: 0.2 seconds, 1.8 seconds, 0.2 seconds, 1.8 seconds, or 2 seconds. In certain variations, the loading time can vary from greater than or equal to about 0.2 seconds to less than or equal to about 50 seconds, optionally greater than or equal to about 0.2 seconds to less than or equal to about 20 seconds, greater than or equal to about 0.2 seconds to less than or equal to about 2 seconds.

A fraction of the first duration over the modulation time is a duty cycle. In certain aspects, the methods and multidimensional chromatographic systems using the flow-restricted pneumatic modulator may have a duty cycle of greater than or equal to about 1% to less than or equal to about 100% and in certain aspects, optionally greater than or equal to about 10% to less than or equal to about 100%. In certain aspects, the flow-restricted pneumatic modulator may have a duty cycle of less than or equal to about 50%, where the duty cycle is a sample/eluent loading time into the second chromatographic column over a modulation time. In certain aspects, the duty cycle (e.g., the sample loading time versus modulation time) ranges from greater than or equal to about 1% to less than or equal to about 50%, and in certain aspects, optionally greater than or equal to about 10% to less than or equal to about 50% (e.g., 0.2 seconds loading time in a 2 second modulation cycle to 1 second loading time in a 2 second modulation cycle). Also, the duty cycle may vary over the entire gas chromatography (GC) system operation. For example, the duty cycle may change from 10% in the first 100 seconds of GC operation to 50% in the remaining time of GC operation.

A maximum modulation time for the flow-restricted pneumatic modulator in the multidimensional chromatographic systems may be less than or equal to about 50 seconds. In certain aspects, a first duration/loading time may be from 0.01% up to 99.99% of the modulation time, while a second duration/separation time may be from 99.99% down to 0.01% of the modulation time, so that a range of the first duration may be greater than or equal to about 0.005 seconds to less than or equal to about 49.995 seconds, while a second duration may likewise be greater than or equal to about 0.005 seconds to less than or equal to about 49.995 seconds. Also, the modulation time may vary over the entire GC system operation. For example, the modulation time can increase from 2 seconds in the first 100 seconds of GC operation to 4 seconds in the remaining time of GC operation.

In one example, a first duration/loading time can be 20 seconds. This allows the flow and the eluents from the first-dimensional column to be diverted to the first channel 64 in the first y-shaped fluid connector 60 to the second inlet 74 to the third outlet 79 in the second y-shaped fluid connector 72 at a low flow rate (for example, 0.5 mL/min volumetric flow rate). The eluents from the first-dimensional column may thus be injected into the second-dimensional column with an injection peak width of approximately 0.2 s. Thus, in certain variations, in the first operational mode, the second chromatographic column has a peak injection width of less than or equal to about 0.2 seconds.

An injection peak width is determined by the first duration/loading time and a ratio of the first dimensional flow rate (flow rate in the first chromatographic column) and second dimensional flow rate (flow rate in the second chromatographic column). For example, if the loading time is 0.2 s, the first dimensional flow rate is 1 mL/min and the second dimensional flow rate is 10 mL/min, then the flow ratio is 10 (10 mL/min divided by 1 mL/min). The injection peak width is 0.2 s/10=0.02 s. In certain variations, an injection peak can be greater than or equal to about 0.001 seconds to less than or equal to about 10 seconds.

In certain aspects, wherein the stream/fluid sample entering the second chromatographic column during the first operational mode has a first flow rate and the auxiliary fluid entering the second chromatographic column during the second operational mode has a second flow rate. A ratio of the second flow rate to the first flow rate is greater than or equal to about 10:1 in certain aspects. More specifically, the ratio between the carrier gas flow rate (5 mL/min) and the loading flow rate (0.5 mL/min) is 10. So the peak width becomes 0.02 s when a 5 mL/min carrier gas is used (without considering other peak broadening and narrowing effects, such as analyte diffusion and analyte plug compression, etc.). In the above embodiment, the injected peak width is 0.2 seconds in the second chromatographic column.

In various aspects, the methods of the present disclosure further comprise repeating the operating the flow-restricted pneumatic modulator in the first operational mode for the first duration and the operating the flow-restricted pneumatic modulator in the second operational mode for the second duration. This may happen over many cycles.

In certain aspects, a net effect is that the eluents from the first-dimensional column can be periodically injected into the second-dimensional column with a certain modulation time (e.g., 1.8 s+0.2 s=2 seconds in the above example) with a duty cycle of 10% (0.2 s divided by 2 s). The first/injection flow rate is low (0.5 mL/min in the above example) and the auxiliary/carrier gas flow rate for the second-dimensional column is high (5 mL/min in the above example). The high ratio makes the injected peak width much sharper than the injection time (i.e., 0.2 injection time produces an injection peak width of 0.02 s in the above example).

In various aspects, the flow-restricted pneumatic modulator prepared in accordance with the present disclosure can provide various advantages to a multidimensional gas chromatography system. First, it provides a slow injection time (or loading time) from the first-dimensional column to the second-dimensional column due to the presence of the high flow resistance of the first flow resistor component 96. This makes the injection peak width much sharper (determined by the ratio between the carrier gas flow rate and the loading flow rate for the second-dimensional column).

Secondly, high auxiliary flow rates can be used to generate very high carrier gas flow rates for the second-dimensional column, without concern that the high auxiliary flow may push the analytes in the first-dimensional column backwards.

Third, it provides lower auxiliary flow consumption, because most of the auxiliary flow is used as the carrier gas for the second-dimensional column. Only a small portion of the auxiliary flow flows downward through the first channel 64 (as discussed above in the second operational mode shown in FIG. 4B). This portion of the flow is to prevent the flow from the first-dimensional column going to the first channel 64. The smaller this part of auxiliary flow is, advantageously the less of the auxiliary flow is wasted.

Nearly no stop is required in the first-dimensional separation. The effective flow rate is reduced from 1 mL/min (assuming 1 mL/min for the first-dimensional flow going to the Lower channel) to (1 mL/min×90%+0.5 mL/min×10%=0.95 mL/min) (assuming the loading flow rate to the second-dimensional column is 0.5 mL/min and 10% duty cycle). Consequently, the first-dimensional separation can be completed quickly.

In certain variations, a length of the upper first channel 64 of the y-shaped fluid connector 60 is as short as possible. In certain variations, an upper limit for the length can be estimated to be the linear speed of the flow (or analyte) in the upper first channel 64 times the loading time. For example, if the linear flow (or analyte) speed is 5 cm/s and the loading time is 0.2 s, then the maximal length for the upper first channel 64 would be 5 cm/s×0.2 s=1 cm. If the upper first channel 64 length is longer than the maximal length, then there will not be sufficient time for the eluents from the first-dimensional column to fully transit to the second-dimensional column. Consequently, a portion of the eluents would be pushed in a backward direction (i.e., from “2” to “1” in FIG. 1) when the auxiliary flow is turned on.

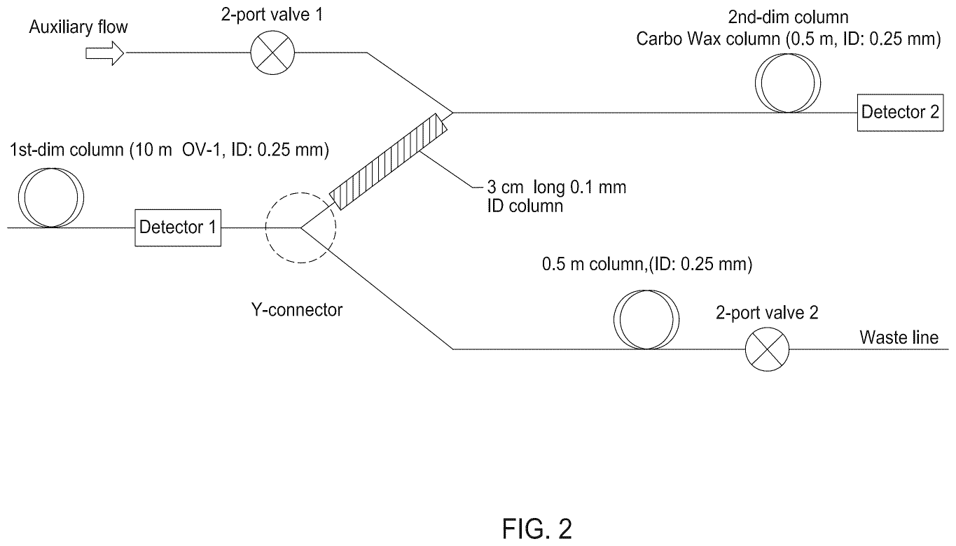

In one variation, an experimental setup and parameters are shown in FIG. 2. In this example, a 3 cm long 0.1 mm inner diameter column (in the upper first channel) is used as a first flow resistor component. A 0.5 m long column is used as a second flow resistor component, which has the same flow resistance as the second-dimensional column, which has exactly the same dimensions (length and inner diameter). When both the first and second flow control valves are open, the flow rate in the first-dimensional column is approximately 1.8 mL/min. When both the first and second flow control valves are closed, the flow rate (i.e., the loading flow rate) through the second-dimensional column is approximately 0.85 mL/min. The carrier gas for the second-dimensional column, which is provided by the auxiliary flow when first flow control valve is open, is 9 mL/min. Two detectors (Detector 1 and Detector 2) are used to monitor the eluents from the first-dimensional and second-dimensional columns, respectively.

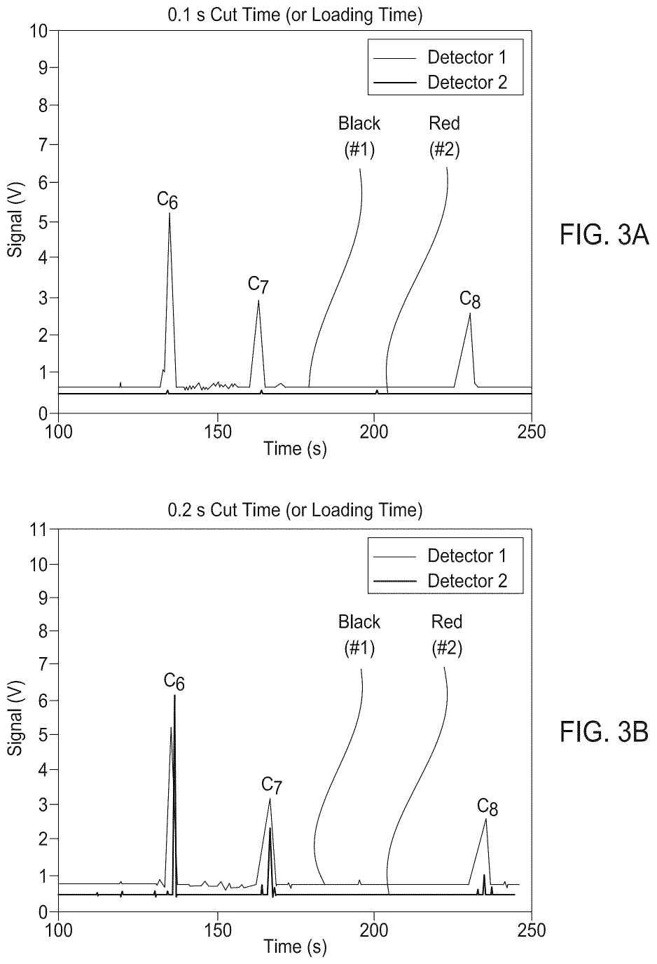

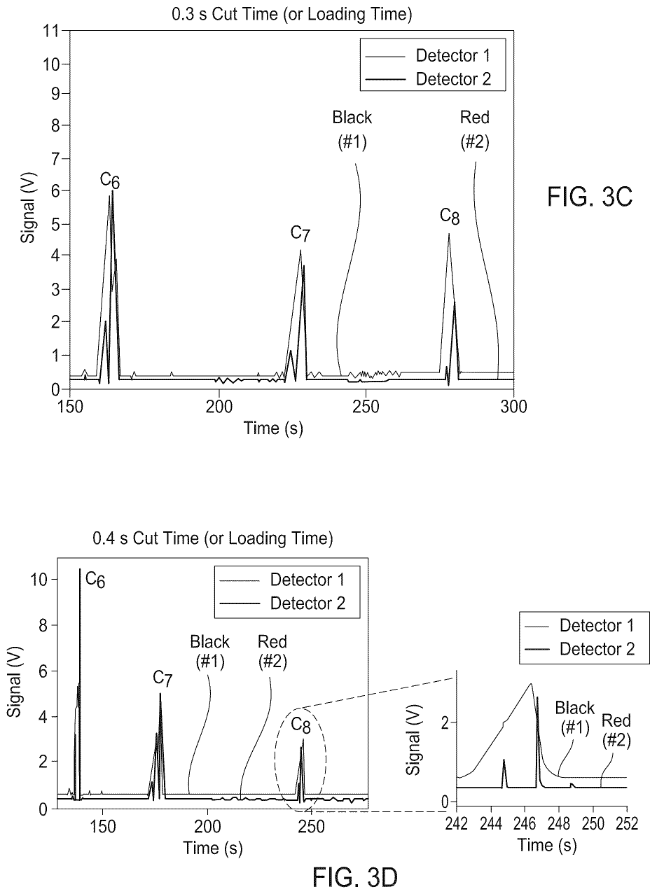

The results are presented in FIGS. 3A-3D. At 0.1 s loading time (FIG. 3A), no eluent from the first-dimensional column is able to travel through the 3 cm long (ID: 0.1 mm) column and reach the second-dimensional column. Consequently, no peak appears in Detector 2. However, when the loading time increases to 0.2 s, 0.3 s, and 0.4 s, eluent peaks appear in Detector 2, which verifies the operation of the FRPM assembly. The peak width on the second-dimensional column increases with the increased cut time or loading time. For example, the peak width (full-width-at-half-maximum) for C₆ is 0.045 s, 0.051 s, and 0.056 s for the loading time of 0.2 s, 0.3 s, and 0.4 s.

In another experiment, the second-dimensional column is removed and Detector 2 is placed right after the junction between the 3 cm (ID: 0.1 mm) column and the auxiliary flow channel. Doing this allows testing of the flow resistor's effect without any interference from the second-dimensional column. Again, C₆, C₇, and C₈ mixture is used. The loading time varies from 0.1 s to 0.5 s. At 0.1 s loading time or cut time, no peaks appear in Detector 2. When the loading time is equal to or longer than 0.2 s, peaks appear in Detector 2. The peak width (full-width-at-half-maximum) for C₆ is 0.038 s, 0.042 s, 0.049 s, and 0.057 s for the loading time or cut time of 0.2 s, 0.3 s, 0.4 s, and 0.5 s, respectively. At a higher loading time (such as 0.5 s), the ratio between the loading time (0.5 s) and the peak width (0.057) approaches the ratio between the carrier gas flow rate (9 mL/min) and the loading flow rate (0.85 mL/min), since at a higher loading time, the peak broadening caused by the detector's internal volume can be ignored (in the experiment, a photoionization detector that has an internal volume of about 2.3 microliters is sued, which corresponds to a sweep time of approximately 0.0023 mL/(9 mL/min)×60 s/min=0.015 s.

Notably, the FRPM assembly described above is not limited to use as an injector or modulator between the first- and second-dimensional columns, and it can be used in front of any column (including the first-dimensional column).

The design, fabrication, and characterization of this FRPM assembly—are further described herein. In certain aspects, an injection peak width of approximately 25 milliseconds (ms) is achieved at a second-dimensional (²D) column/first-dimensional (¹D) column flow rate ratio over 10 without first-dimensional (¹D) column perturbation. Subsequently, the flow-restricted pneumatic modulator, also referred to herein as the microfabricated chip-based flow-restricted pneumatic modulator (FRPM) was monolithically integrated with a 0.5 m ²D column on a single chip. Finally, a first in kind automated comprehensive 2D μGC device was developed, consisting of a 10 m OV-1 ¹D microfabricated column (μcolumn), an integrated FRPM with a built-in 0.5 m WAX (i.e., polyethylene glycol (PEG)) ²D μcolumn, and two flow-through micro-photoionization detectors (μPIDs). Rapid separation of 40 volatile organic compounds (VOCs) in 5 minutes is also demonstrated. A 2D contour plot was constructed by using both ¹D and ²D chromatograms obtained with the two μPIDs at the end of the ¹D and ²D μcolumns, showing improved peak capacity compared to the conventional comprehensive 2D GC that uses only one vapor detector at the end of the ²D column.

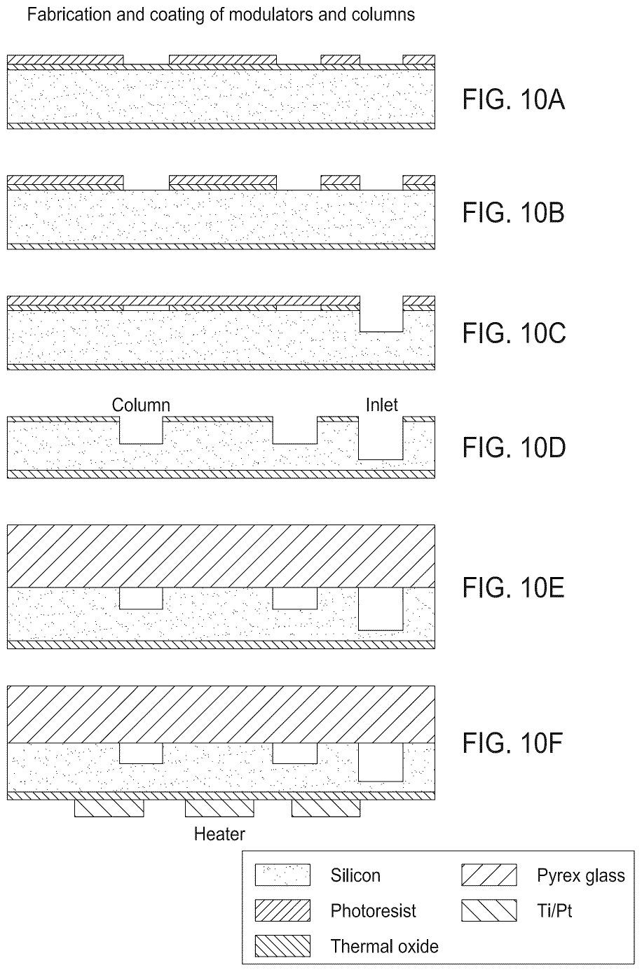

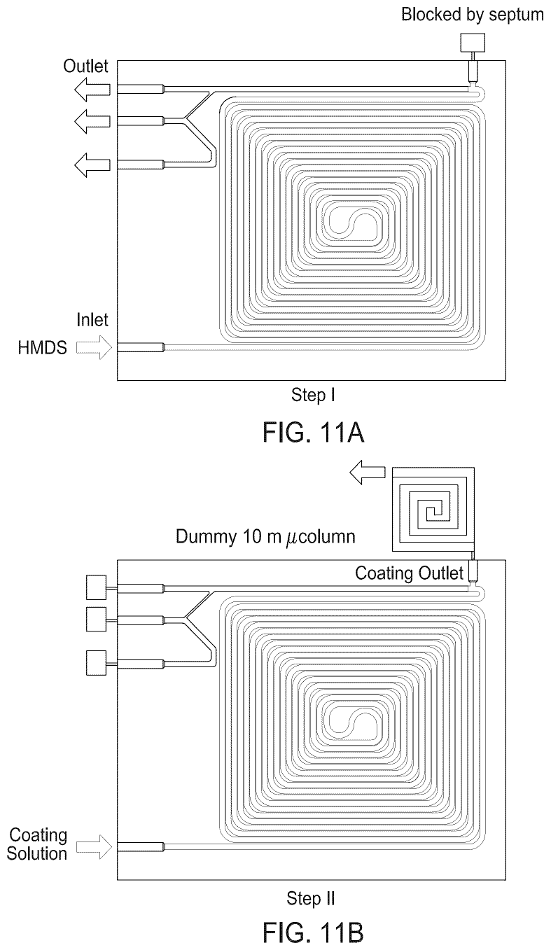

A block diagram for the FRPM along with its operation is provided in FIGS. 4A-4D. The FRPM comprises an inlet for auxiliary flow (Port 1), an inlet for ¹D eluents (Port 2), an outlet connected to the ²D column (Port 3), and an outlet as the waste line (Port 4), as well as an internal flow resistor between ¹D and ²D. The auxiliary flow and waste/bypass line are controlled by two 2-port valves. During loading in the first operational mode (FIG. 4(A)), both valves are closed and a portion of the ¹D eluent is loaded onto the ²D column through the flow resistor component, as previously described above. During ²D separation (FIG. 4(B)) in the second operational mode, both valves are open, and a high auxiliary flow simultaneously provides the ²D carrier gas flow for ²D separation and the buffer flow that prevents the ¹D eluent from entering the ²D column. Concurrently, ¹D separation continues and the ¹D eluent is diverted to the waste/bypass line. After ²D separation, both valves are closed again, and a new modulation cycle begins. Fabrication of the FRPM is schematically shown in FIGS. 10A-10F and 11A-11B.

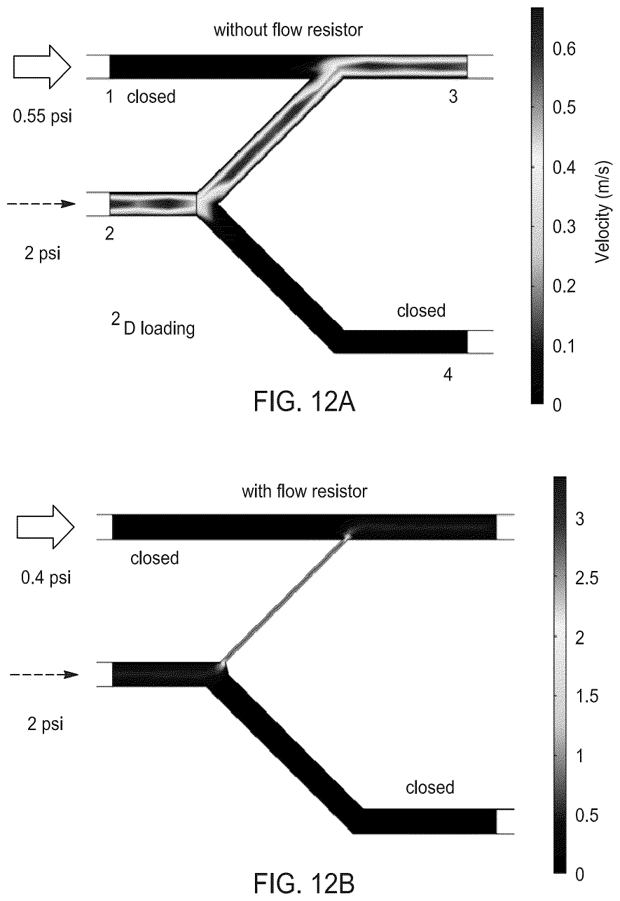

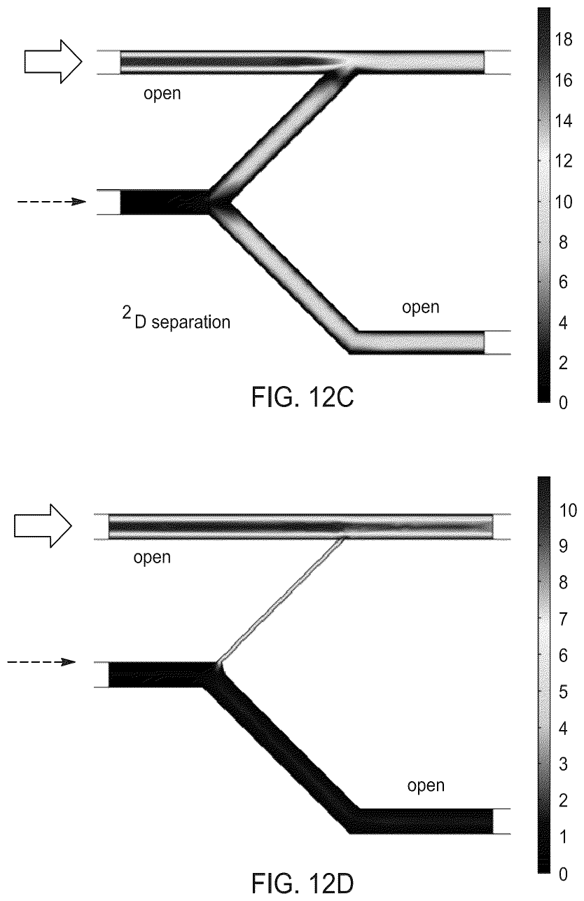

Compared to the previously aforementioned conventional pneumatic modulators, the FRPM modulator assembly has several advantages. First, high auxiliary flow rates can be used for sharp ²D injection and rapid ²D separation. Second, the flow resistor restricts the auxiliary flow that is spent on the waste line (see FIGS. 12A-12D), which saves the auxiliary flow. Third, again due to the flow resistor, the impact of the auxiliary flow on ¹D flow and separation is minimized. Consequently, a large range of auxiliary flow rates and ¹D flow rates can be selected without ¹D flow perturbation (such as flow shocks upon modulation switching and ¹D backflow). This allows for detection right after the ¹D outlet to directly monitor ¹D separation (further discussion follows). In contrast, designs without the flow resistor (e.g., conventional Deans switch) require careful ¹D and auxiliary flow balancing and may still experience flow fluctuations during modulation. Fourth, the eluent concentration (or density) at the transfer junction from the ¹D outlet to the ²D inlet is preserved. In contrast, a Deans switch relies on the auxiliary flow to push the eluent from ¹D to ²D, consequently diluting the eluent concentration and reducing the ²D signal when a concentration dependent vapor detector (e.g., PID) is used. Fifth, ¹D separation is continuous (unlike in stop-flow modulation), which expedites ¹D separation and reduces ¹D peak broadening. Sixth, the FRPM assembly prepared in accordance with certain aspects of the present disclosure is versatile and can be operated in stop-flow mode by permanently closing the waste line valve and letting the ¹D and auxiliary flow share the same pressure/flow source, as discussed further below. Seventh, the FRPM assembly prepared in accordance with certain aspects of the present disclosure can be easily microfabricated and even integrated with the ²D column on a single chip.

Each FRPM chip had dimensions 8 mm×5 mm×1 mm (length×width×thickness). FIG. 4(C) illustrates the schematic of the microfluidic channels inside the FRPM, with a 2 mm long, 40 μm×170 μm (width×depth) channel as the built-in flow resistor component. The flow resistor component's width and depth can be adjusted to achieve different flow resistances. All other channels had cross sections of 250 μm×250 μm. FRPM modules were constructed by connecting the FRPM chip to two 2-port valves at the corresponding ports (FIG. 4(D)).

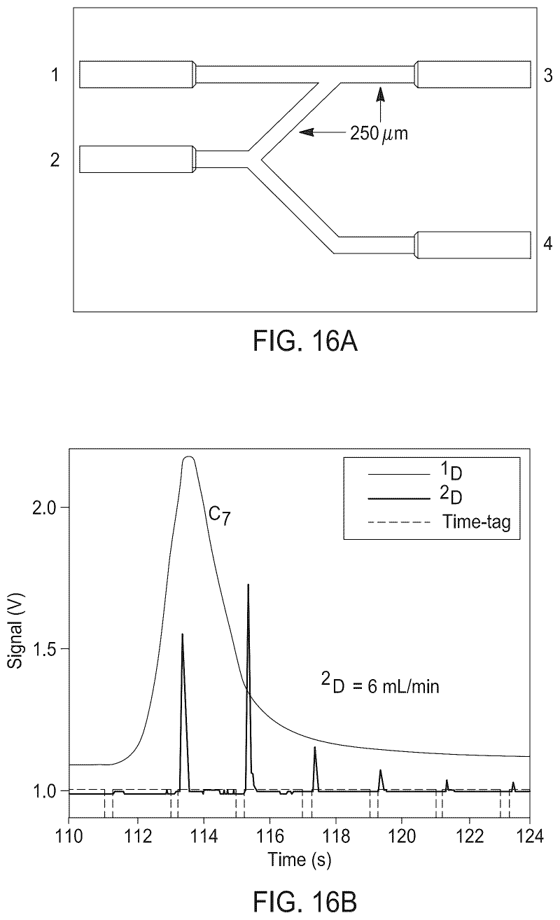

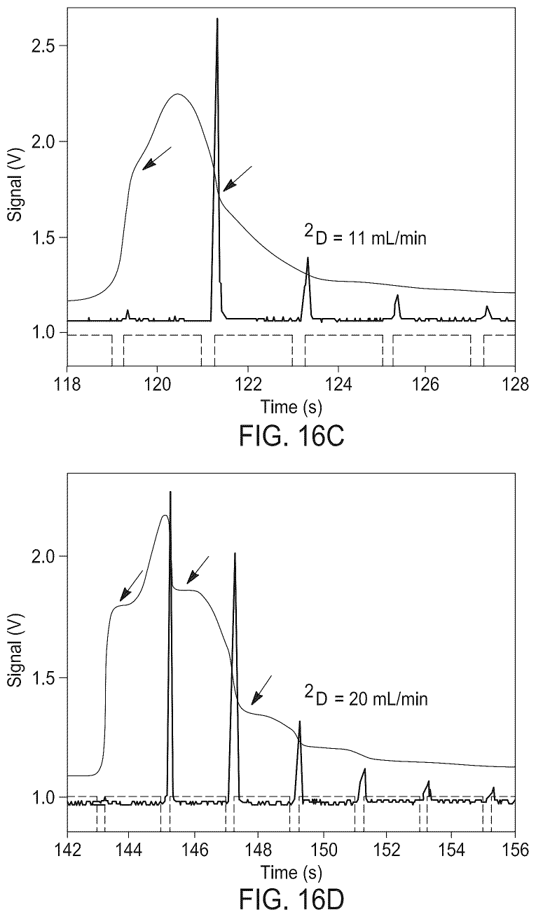

FIGS. 12A-12D present computational fluid dynamics (CFD, COMSOL Multiphysics®) results for the FRPM with a flow resistor and a pneumatic modulator without a flow resistor (i.e., the 40 micrometer wide channel is replaced with a 250 micrometer wide channel). The entire simulation geometry includes a 10 m 250 micrometer wide column (not shown) attached to the FRPM module. The geometry of the FRPM is the same as the shown in FIG. 1 and FIGS. 16A-16D (without flow resistor). Laminar flow module was used in the simulation where helium was used as the gas flow and silicon was used as the walls. Input pressures were assigned at the inlet of the 10 m column (2 psi) and at the inlet of Port 1 in the FRPM module (0.55 psi for the FPRM without a flow resistor (FIGS. 12A, 12C)), and 0.4 psi for the FRPM with a flow resistor (FIGS. 12B, 12D). Closed valves were simulated by assigning an extremely large viscosity (i.e., 10000) at a short portion of the inlet (Port 1) and the waste line (Port 4) simultaneously.

During ²D loading, the velocity stays the same (FIGS. 12A, 12B) for the FRPM without or with a flow resistor, because the additional flow resistance resulting from the 40 μm narrow channel of the FRPM is negligible compared to the upstream 10 m column. This agrees with the experimental results (FIG. 2). During ²D separation, the FRPM without a flow resistor requires a higher input pressure from Port 1 (0.55 psi versus 0.4 psi) such that the flow rate at Port 3 is maintained to be the same as that of the FRPM with a flow resistor (see FIGS. 3C, 3D). Comparison between FIGS. 12C and 12D shows that during ²D separation, the auxiliary flow from Port 1 diverts more flow to ²D (as the ²D carrier gas) when the FRPM with a flow resistor is used. Meanwhile, the ¹D flow is diverted to the waste line by the buffer flow passing through the flow resistor, which prevents the ¹D flow from entering ²D and allows for ¹D separation to continue without significant interruption.

### EXAMPLES

Analytical standard-grade hexane, heptane, octane, benzene, toluene, hexamethyldisilazane (HMDS), and the 40 VOCs listed in Table 1 are purchased from Sigma-Aldrich (St. Louis, MO).

TABLE 1
40 VOCs used in the comprehensive 2D μGC system.

| # | Analyte |
|---|---|
| 1 | isopropanol |
| 2 | acetone |
| 3 | ethyl acetate |
| 4 | 1-pentanol |
| 5 | hexane (C₆) |
| 6 | THF |
| 7 | benzene |
| 8 | heptane (C₇) |
| 9 | methylisobutylketone |
| 10 | pinacolyl alcohol |
| 11 | toluene |
| 12 | octane (C₈) |
| 13 | butyl acetate |
| 14 | ethylbenzene |
| 15 | xylene |
| 16 | styrene |
| 17 | 2-pentanone |
| 18 | nonane (C₉) |
| 19 | 1,2-dichlorobenzene |
| 20 | Cyclohexane |
| 21 | decane (C₁₀) |
| 22 | undecane (C₁₁) |
| 23 | 2-nonanone |
| 24 | trans-2-hexene-1-al |
| 25 | 1,4-dioxane |
| 26 | Hexanal |
| 27 | 2-hexanone |
| 28 | 1-chlorohexane |
| 29 | Cumene |
| 30 | 2-heptanone |
| 31 | Heptanal |
| 32 | 2-methylfuran |
| 33 | Benzaldehyde |
| 34 | 2-pentanone |
| 35 | Methylcyclohexane |
| 36 | Chlorobenzene |
| 37 | 1-hexanol |
| 38 | Dipentene |
| 39 | benzyl chloride |
| 40 | 1-chlorobutane |

N-type silicon wafers (P/N 1095, 100 mm diameter, 500 μm thickness), P-type heavily doped wafers (100 mm diameter, 0.001-0.005 Ω-cm, 400 μm thickness) and Borofloat 33 glass (P/N 517) were purchased from University Wafer. Carbopack B (P/N 20273) and X (P/N 10437-U) were purchased from Sigma-Aldrich. Additional accessory materials are provided in Table 2.

TABLE 2
Accessory materials for the system assembly.

| Item | P/N | Company |
|---|---|---|
| Norland optical adhesive 68T | 68T01 | Norland |
| Hysol 1C Epoxy | 1373425 | Ellsworth Adhesive |
| Deactivated fused silica | 10010 | Restek |
| tubing | | |
| Universal press-tight | 20401 | Restek |
| connectors | | |
| 21.5-gauge stainless steel | 8988K54 | McMaster-Carr |
| tubing | | |
| Glass wool | 20411 | Sigma Aldrich |
| 32-gauge nickel chromium | 32BNC | Consolidated |
| wire | | |
| Krypton lamp for PID | 043-257 | MOCON baseline |
| PCB board | Not applicable | M.A.K.S. |
| 3-port valve | LFRA1220170D | Lee Company |
| 3-port valve | LHDA1231315H | Lee Company |
| 2-port valve | LHDB1252115H | Lee Company |
| Pump | T3HP-1PD-12- | Parker Hannifin |
| | 1SNP | |
| Transformer for PID | CCFL FL3209 | Coil Craft |
| excitation | | |
| DC to DC convertor | 78B12 | Digikey |
| Copper mesh | B08PT35XRD | Amazon |
| Power supply | 1866-RPS-120S- | Digikey |
| | 24-ND | |
| Tedlar bag | 22952 | Restek |

All materials were used as purchased without further purification or modification. 99.5% purity helium (P/N 49615He) was used as the carrier and auxiliary gas and was purchased from Leland Gas Technologies (South Plainfield, NJ).

### Component Fabrication

The 10 m ¹D microcolumn (cross section: 200 μm×250 μm, width×depth), the stand-alone FRPM, and the integrated FRPM and 0.5 m ²D μcolumn were fabricated according to the fabrication process in FIGS. 10A-10F. FRPM module/chips were microfabricated using the same process as for microcolumns (details in FIGS. 10A-10F). The μcolumn microfabrication process involves first in FIG. 10A, using a soft mask of photoresist exposing both column and inlets/outlets. Next in FIG. 10B, creating an oxide hard mask through DRIE (deep-reactive-ion-etching). In FIG. 10C, creating a soft mask by exposing only inlets/outlets for DRIE to 150 μm. In FIG. 10D, using DRIE on the entire pattern area to etch inlets/outlets to 400 μm and column to 250 μm depths. FIG. 10E, BHF (buffered hydrofluoric acid) is used to strip off an oxide mask and anodic bonding with Pyrex glass to seal the column. Finally, in FIG. 10F, a patterned metal heater (30 nm Titanium/320 nm Platinum) is deposited on the backside.

The stand-alone FRPM had no heater on the backside of the chip, but the integrated FRPM and ²D μcolumn was fabricated with a shared backside heater. The fabrication yield for the stand-alone FRPM is greater than about 95% (132 chips per 4-inch wafer), greater than about 90% for the integrated FRPM (12 chips per 4-inch wafer) and greater than about 50% for the 10 m μcolumn (2 chips per 4-inch wafer).

The integrated FRPM with 0.5 m ²D μcolumn (cross section: 250 μm×250 μm) coating procedure is depicted in FIGS. 11A-11B. Prior to coating, both the ²D μcolumn and FRPM channels were deactivated by eight repeated injections of HMDS at 120° C. over 1 h. The coating outlet was blocked with a rubber septum during deactivation. During ²D μcolumn coating, the outlets of the FRPM were blocked, leaving only the coating outlet open to ensure that no coating solution flowed into the FRPM channels. A dummy 10 m μcolumn was attached to the coating outlet as a flow resistor to control the coating flow speed. The ²D μcolumn was dynamically coated with PEG by injecting 15 μL of solution and pushing out at a rate of 5 cm/min. PEG: 2% (w/w) solution of CarboWAX 20M in dichloromethane with azobisisobutyronitrile (1% w.r.t. CarboWAX) as crosslinker. The coating was repeated 2 times.

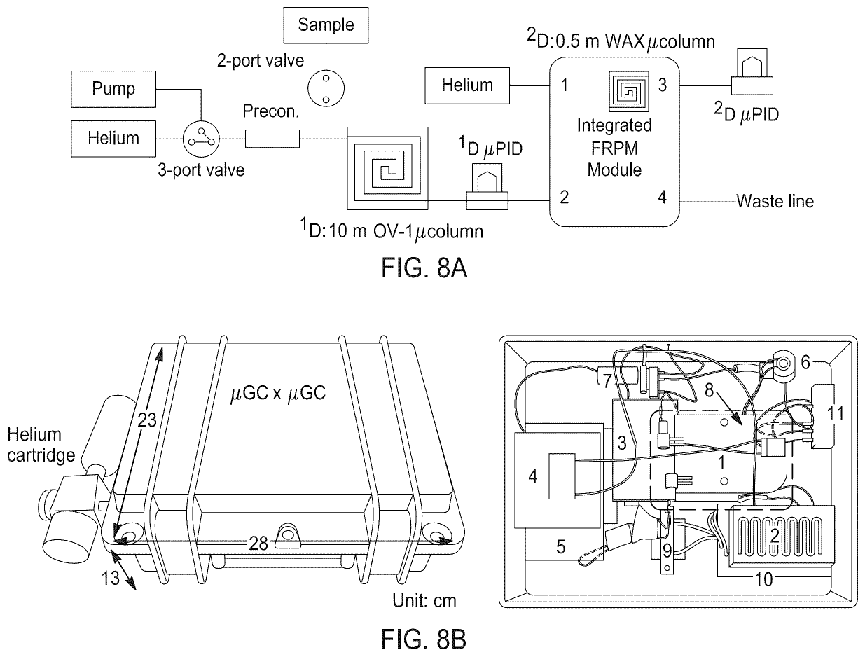

The column was subsequently treated with HMDS after each coating and then baked out at 180° C. for 1 h prior to use. Finally, the guard column attached to the coating outlet was removed and HYSOL™ epoxy was applied to block the outlet. The 10 m μcolumn underwent the same coating procedure with a 3% (w/w) solution of OV-1 in dichloromethane. The resistance of the integrated heater was measured to be 40Ω for the integrated FRPM chip and 28Ω for the 10 m μcolumn. Both columns were wire bonded to PCB boards to allow for pulse-width-modulated heating using a peak voltage of 24 V. The μPID chip was fabricated as described in our previous work. The μPID array is packaged on a PCB board as shown in FIG. 8B.

The stainless steel preconcentrator was made by first cutting a 21.5-gauge stainless steel tube to 3.5 cm in length. One end was first plugged with glass wool. Subsequently, the tube was filled with 0.75 mg of Carbopack B, followed by 0.75 mg of Carbopack X, and the other end was then plugged with glass wool again. Two universal press-tight connectors were attached to both ends of the stainless steel tube after loading and fixed using Hysol epoxy. A very thin layer of epoxy (approximately 0.2 mm) was also applied to the outer surface of the stainless steel tube body. The entire preconcentrator was placed into an oven at 120° C. and left to dry for 12 h. Finally, a KAPTON™ tape was wrapped around the stainless steel tube before wrapping a 32-gauge nickel chromium heating wire (resistance approximately 7Ω) to ensure electrical isolation between the stainless steel tube and heating wires.

### Comprehensive ²D μGC System Setup and Operation

The comprehensive ²D μGC system includes a stainless steel preconcentrator, a 10 m OV-1 coated ¹D μcolumn, an integrated FRPM and 0.5 m ²D WAX μcolumn, and two flow-through μPIDs at the end of ¹D and ²D, respectively. Components were interconnected using universal press-tight connectors and deactivated fused silica capillaries. A detailed schematic along with a device depiction is shown in FIG. 8B. The ¹D flow rate was calibrated at the end of the ²D μPID (Port 3) with both valves closed. The ²D flow rate was calibrated at the end of the ²D μPID by opening both valves at the auxiliary flow inlet (Port 1) and waste line (Port 4). Analytes were stored in a TEDLAR™ bag and sampled into the preconcentrator before backflush injection into the ¹D μcolumn. During operation, the analytes are separated by the ¹D column, flow through the ¹D μPID, and subsequently enter the FRPM module for ²D comprehensive modulation and separation. Separation was conducted using temperature ramped programming in both dimensions via the integrated backside heaters. Helium (99.5% purity) was used as the carrier and auxiliary gas. Loading and modulation times were set by simultaneously controlling the valves' ON and OFF states at the auxiliary flow inlet (Port 3) and waste line (Port 4).

Segmented modulations are achieved by assigning different loading and modulation times to different segments of analysis. The current work used modulation times of 1 s from 0 to 75 s, 2 s from 75 to 180 s, and 3 s from 180 to 350 s. The loading time was kept at 0.4 s during all segments. Portable μGC operation was controlled by in-house developed LabVIEW™ software.

### 2D Chromatogram Construction

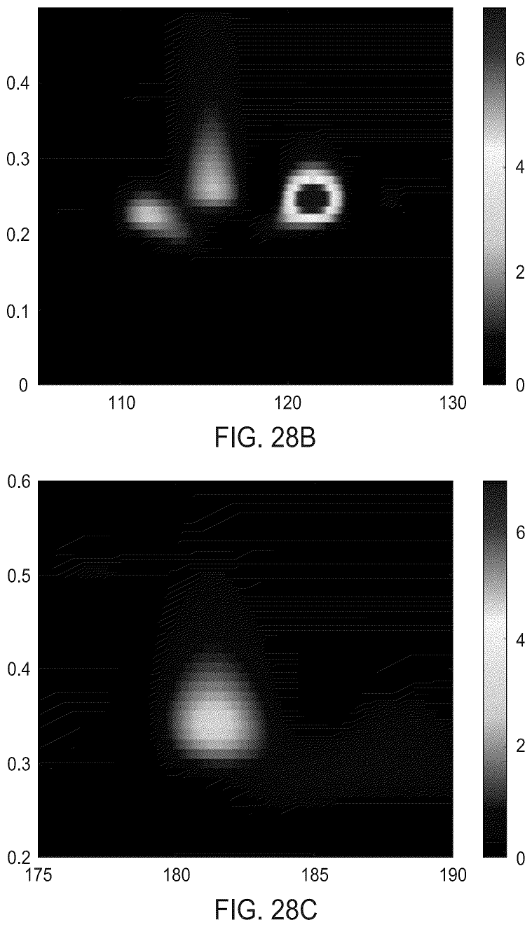

The 2D contour plots in FIGS. 28A-28C use the traditional method adopted in conventional comprehensive 2D GC that has only one detector at the outlet of the ²D column (i.e., no detector at the end of the ¹D column). They are generated through the 2D interpolation of the original 2D GC data based on a cubic spline. The interpolated value at a query grid point is based on a cubic interpolation of the values at neighboring grid points in each respective dimension.

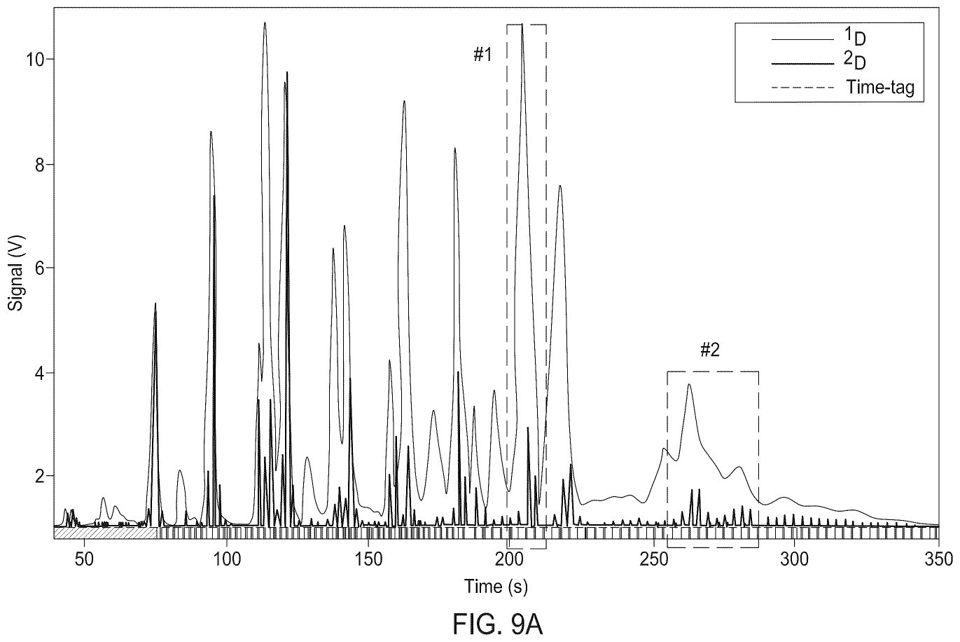

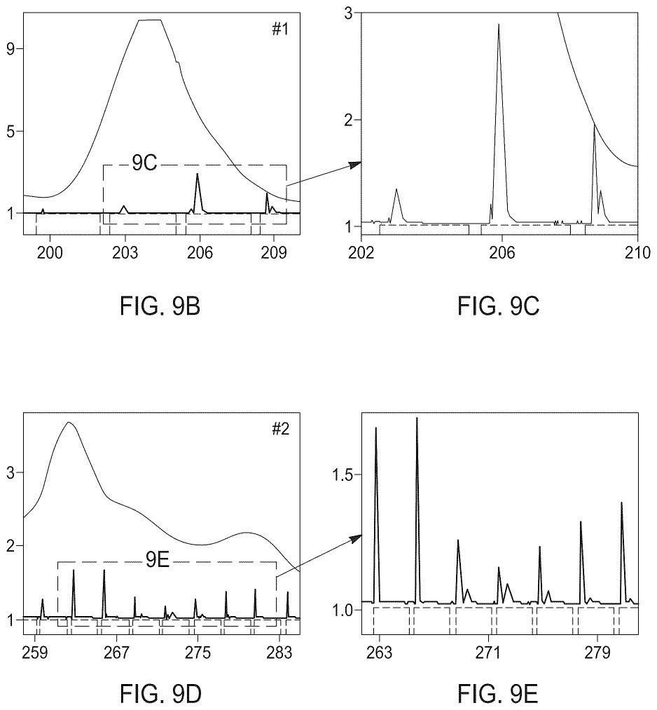

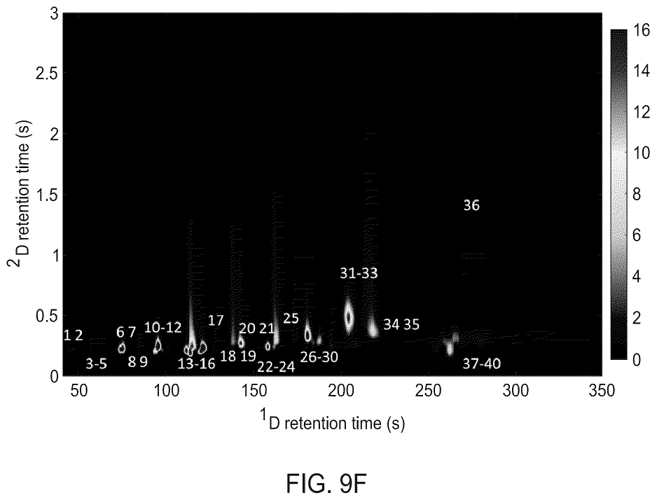

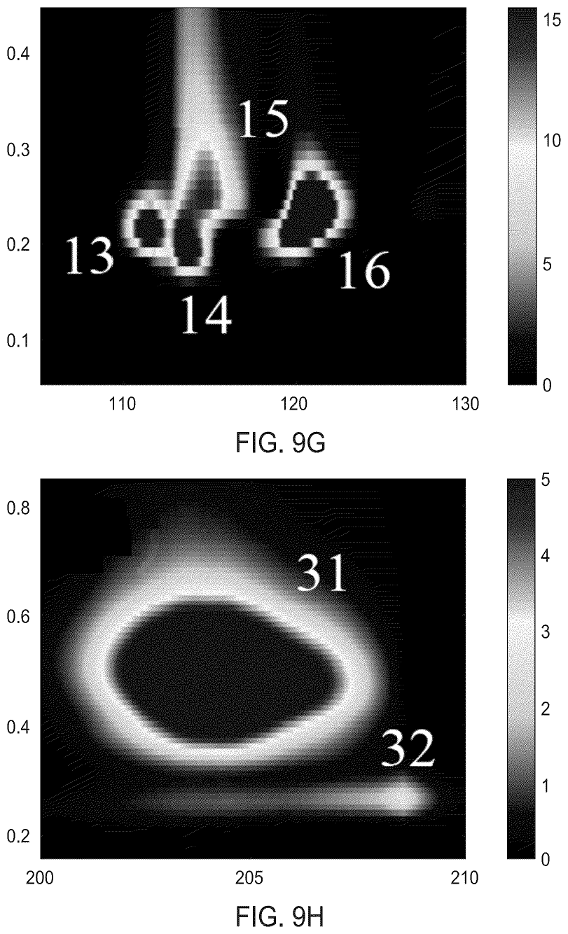

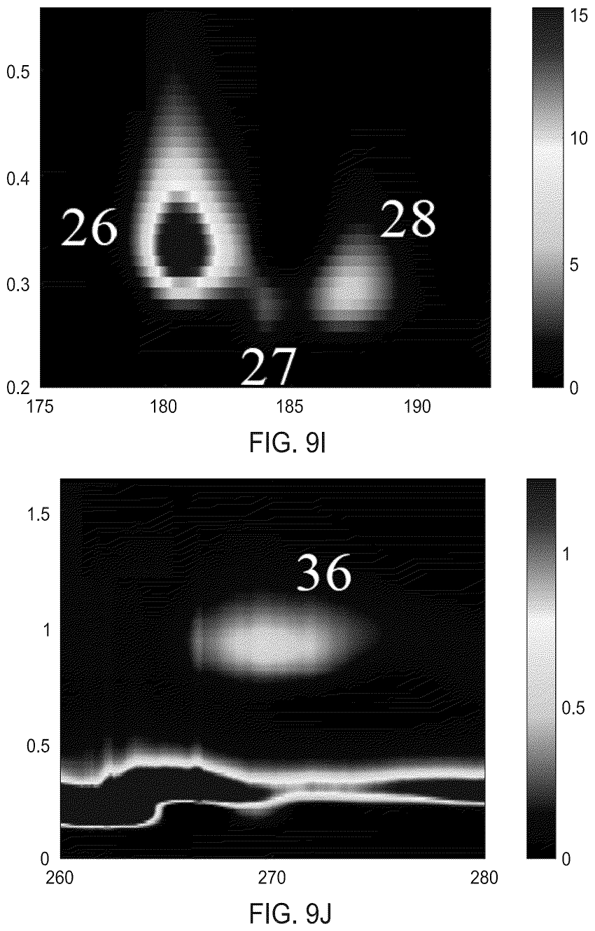

The 2D contour plot in FIGS. 9F-9J use the signal obtained from both ¹D and ²D μPIDs. The traditional interpolation method based on a cubic spline is first performed using the ²D GC data. ¹D GC data is then adopted to correct the contour data along the ¹D direction, while peak shapes along ²D direction are preserved.

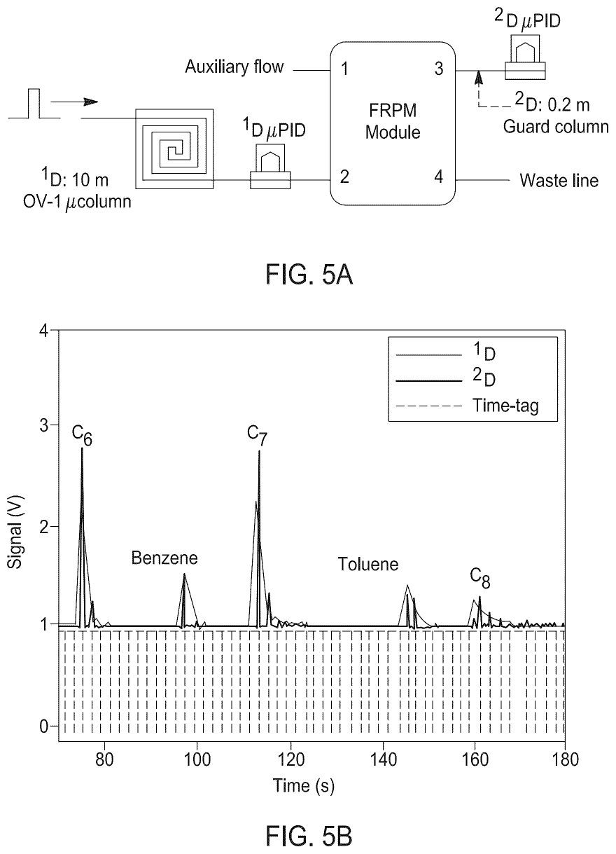

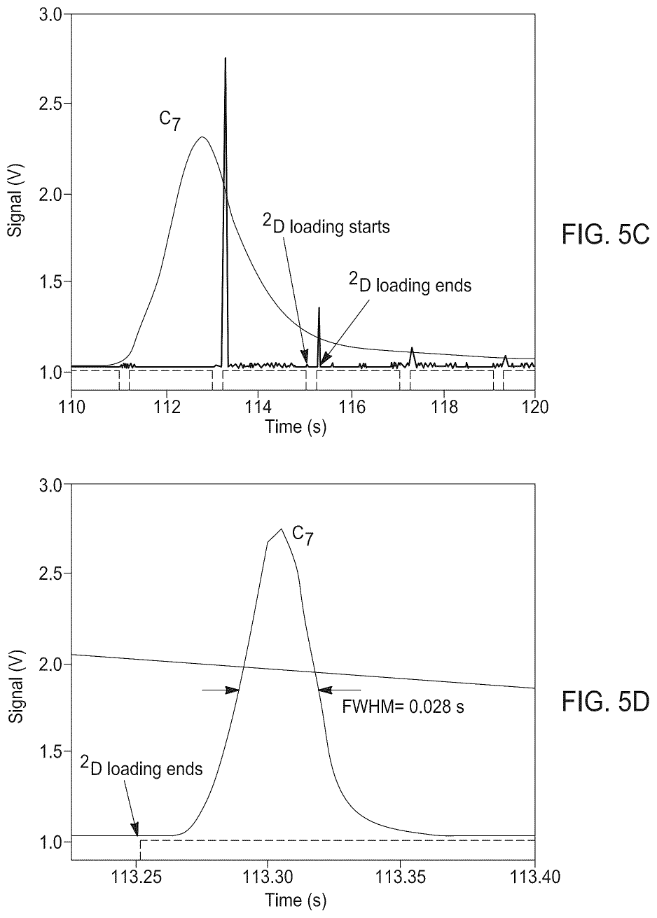

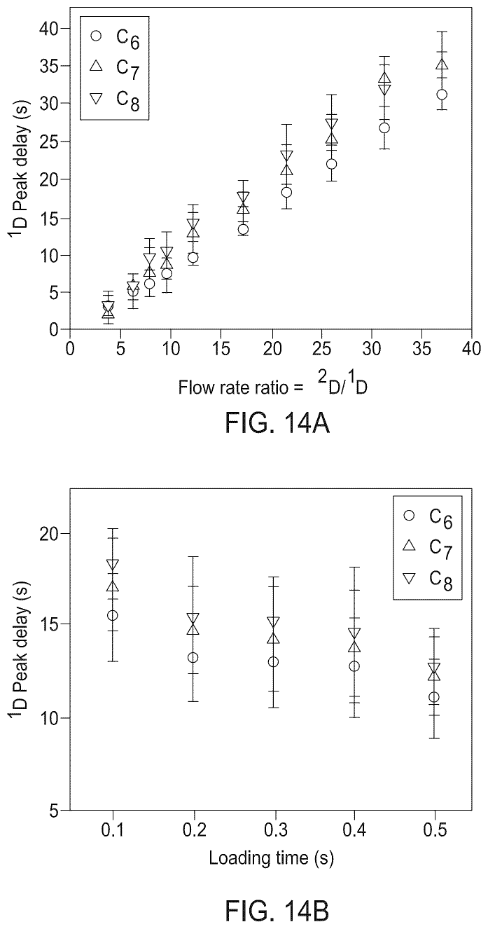

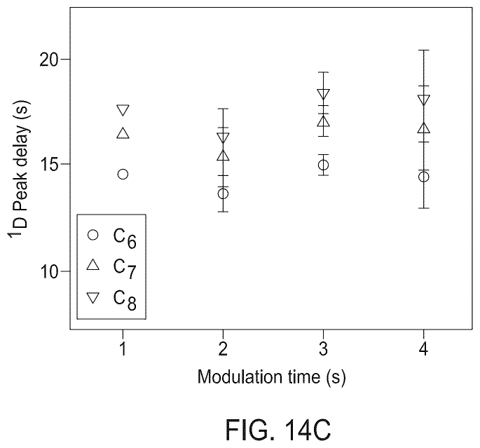

As illustrated in FIG. 5A, ²D injection using the FRPM module was characterized with only a 10 m OV-1 ¹D microcolumn and a 20 cm guard column in ²D (no ²D separation column). Two flow-through μPIDs were used to measure and compare eluents right before and after the FRPM. Initial characterization was carried out using unmodulated operation (chromatograms in FIG. 14A). All ¹D eluents were transferred to ²D with slight delays between the eluent peaks detected by the ¹D and ²D μPID, which increased for heavier compounds. These delays resulted from the 20 cm guard column in ²D. Comparison of the C₆ and C₇ peak height showed that the ²D μPID is about 2.4 times more sensitive than the ¹D μPID. Relative peak heights for other compounds were reduced in the ²D μPID as compared to ¹D again due to peak broadening resulting from the 20 cm guard column.

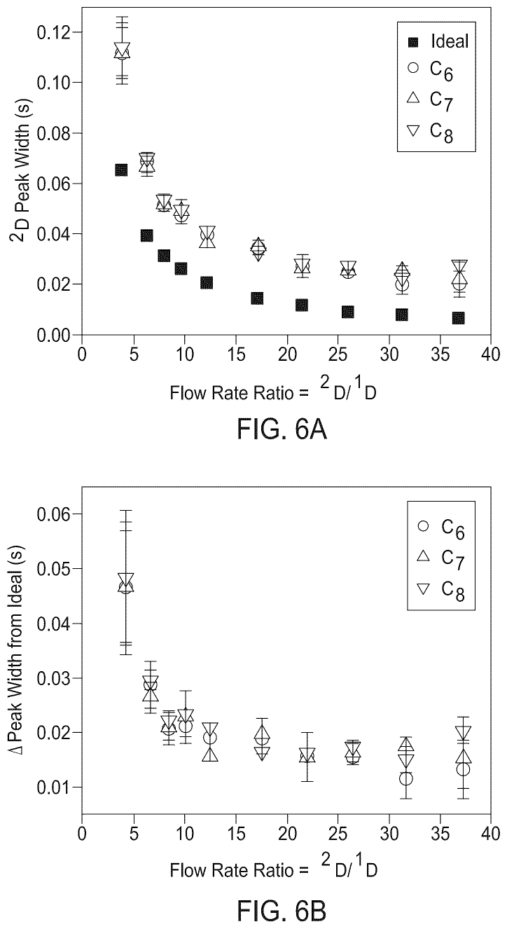

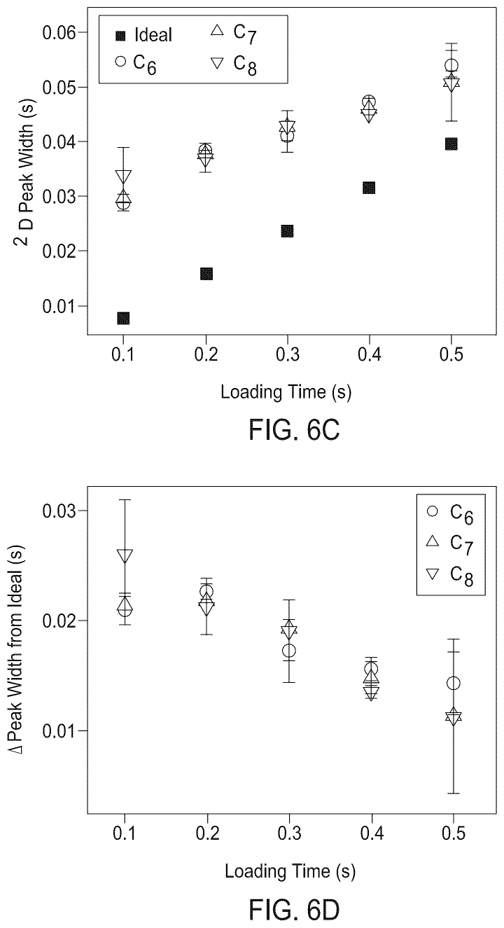

Modulated operation was investigated next. FIGS. 5B-5D show an example of ¹D and modulated ²D chromatograms using alkanes and aromatics. Since sharp ²D injections are important for maximizing ²D peak capacity, the ²D injection peak width (defined as the full-width-at-half-maximum) for C₆, C₇, and C₈ as a function of the flow rate ratio between ²D and ¹D (²D/¹D) was examined (FIG. 6A). In general, the injection peak width decreases with increased ²D/¹D flow rate ratio. However, the measured injection peak width is always broader than the ideal peak width (defined as the loading time divided by ²D/¹D flow rate ratio). This broadening is caused by the 20 cm guard column and the broadening versus flow rate can be viewed as the Golay plot of said column (FIG. 6B). The ²D injection peak width is also affected by loading time and is characterized in FIG. 6C at a fixed flow rate ratio of 13. The measured peak width increases linearly with increased loading time and is again broader than the theoretical value. The broadening effect diminishes with longer loading times (FIG. 6D) since the broadening from the guard column becomes less dominant. As described further below in the context of FIGS. 14A to 21B, the maximally allowed ²D/¹D flow ratio without affecting the ¹D flow and peak height (and peak area) for different loading times is explored, as well as comparison between the modulator with and without the flow resistor. Based on these, an injection peak as sharp as approximately 25 ms can be achieved with a loading time of 0.25 s and a flow rate ratio larger than 10 without perturbing the ¹D flow or significantly slowing down ¹D separation.

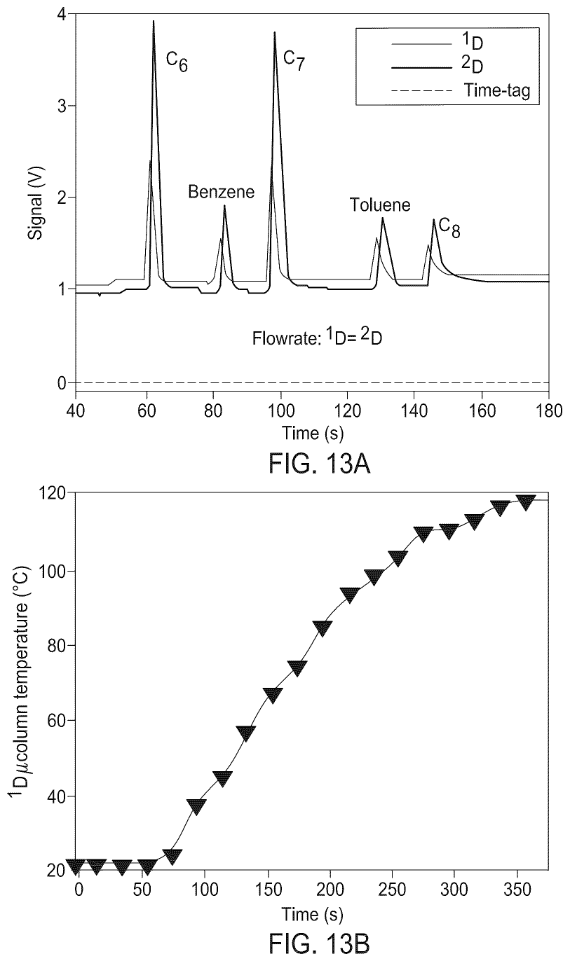

FIGS. 13A-21B provide additional characterization of FRPMs prepared in accordance with certain aspects of the present disclosure in terms of the maximally allowed ²D/¹D flow ratio and peak height (and peak area) for different loading times, as well as the comparison between the modulator with and without the flow resistor.

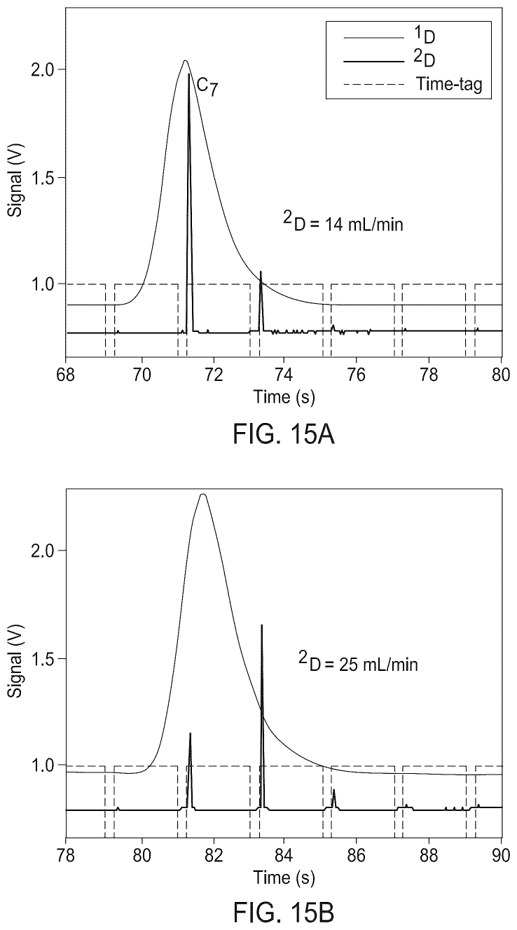

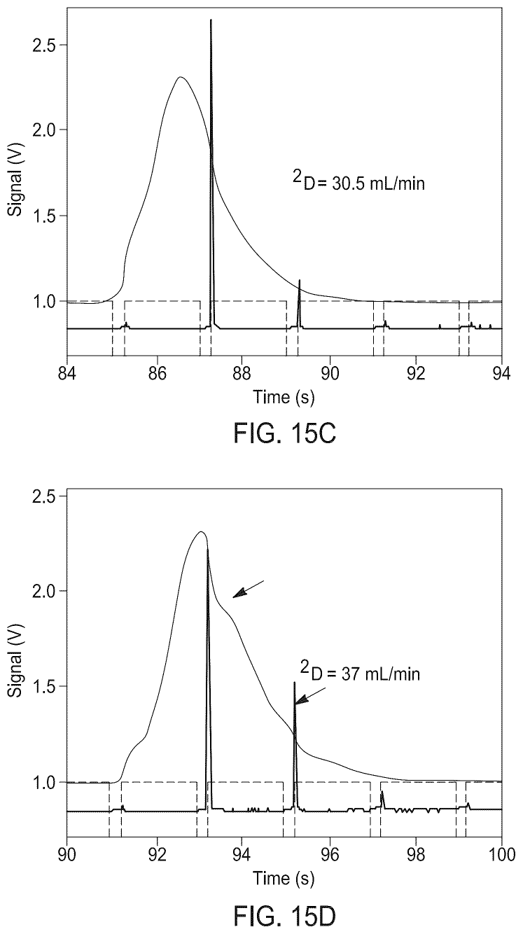

As mentioned above, a high flow rate ratio is desired in order to generate a sharp ²D injection peak and expedite ²D separation. However, at an excessive flow rate ratio (i.e., strong auxiliary flow), the ¹D flow is slowed down or even pushed backwards, causing delay in ¹D retention time measured by ¹D μPID (see FIGS. 14A-14D) and jittering in ¹D chromatogram (see FIGS. 15A-15D). Delay in retention time prolongs the analysis time and reduces the peak capacity and jittering makes ¹D chromatogram analysis (such as peak fitting and apex identification) nearly impossible. The flow resistor (i.e., the narrow channel) in the FRPM significantly mitigates the ¹D retention time delay and jittering at a high flow rate ratio.

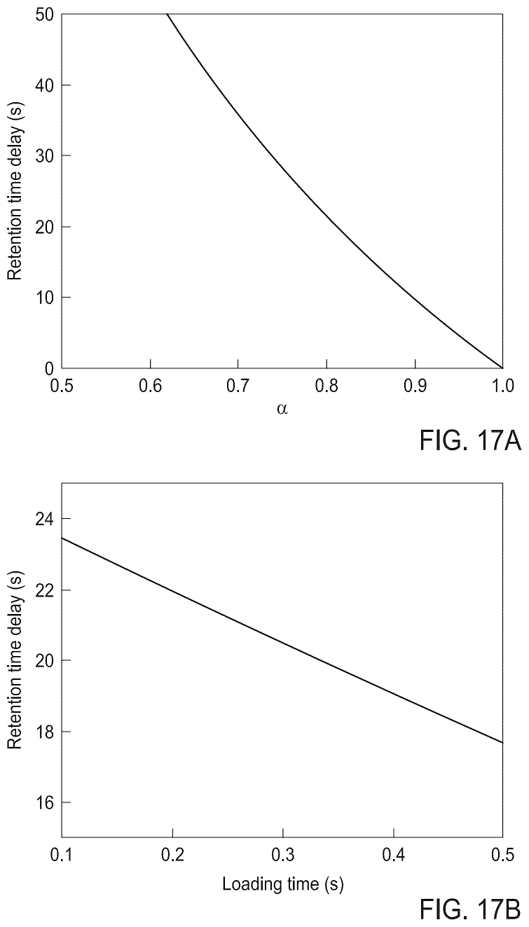

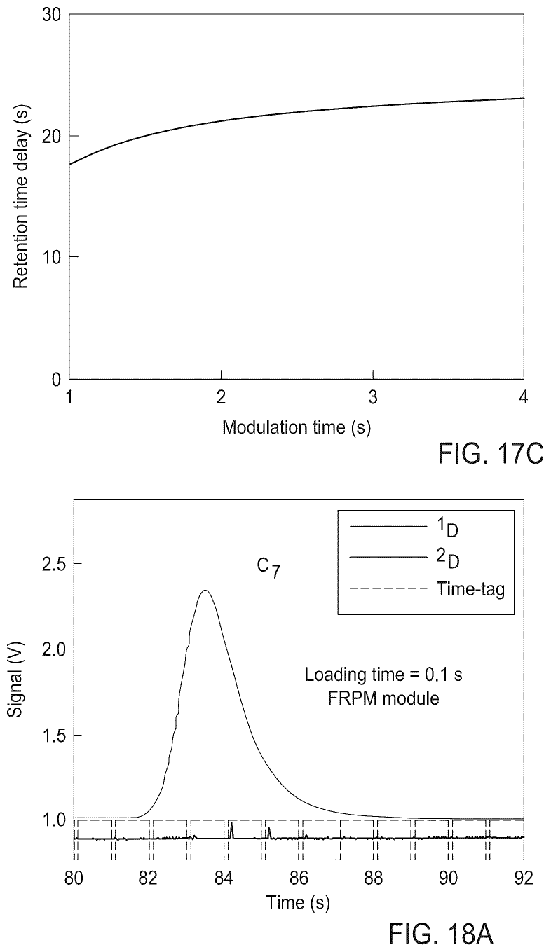

FIGS. 14A-14C show ¹D peak delays of C₆, C₇, and C₈ detected by ¹D μPID versus flow rate ratio (FIG. 14A), loading time (FIG. 14B), and modulation time (FIG. 14C). Experimental conditions: (FIG. 14A) and (FIG. 14C) loading time=0.25 s. FIG. 14B loading time=0.1 to 0.5 s. FIGS. 14A and 14B modulation time=2 s. FIG. 14C modulation time=1 to 4 s. FIG. 14A ²D flow rate=4 to 40 mL/min. FIGS. 14B and 14C have ²D flow rate=16 mL/min. For all experiments, ¹D flow rate=1.2 mL/min. Error bars are obtained with 3 measurements. The results agree qualitatively with the theoretical calculations shown in FIGS. 17A-17C.

According to FIGS. 14A-14C, no significant delay in the ¹D eluent's retention time was observed compared to the unmodulated case. For example, ¹D retention time for C₇ was 120 s and 100 s, respectively, for modulated (at a flow rate ratio of 20) and unmodulated operation (see FIG. 13A)). Additionally, according to FIGS. 15A-15D, even at the flow rate ratio of 17 (²D flow=20 mL/min), the ¹D chromatogram is still well-behaved and smooth. The jittering does not emerge until when the flow rate ratio is above 20 (²D flow rate=25 mL/min). In contrast, when the modulator was operated without the 40 μm wide flow resistor (i.e., the flow resistor's channel width became 250 μm rather than 40 μm—see FIG. 16A), not only the ¹D retention time was significantly delayed (for example, C₇ retention time became 145 s at the same flow rate ratio of 20), but the ¹D peak was strongly perturbed (see FIGS. 16C-16D) at a low flow rate ratio (such as 9 when ²D flow=11 mL/min).

FIGS. 15A-15D show magnified ¹D and ²D chromatograms of C₇ using the FRPM module. ²D flow rate=14 mL/min (FIG. 15A), 25 mL/min (FIG. 15B), 30.5 mL/min (FIG. 15C), and 37 mL/min (FIG. 15D). For all experiments, ¹D flow rate=1.2 mL/min, loading time=0.25 s, and modulation time=2 s. Black arrows indicate the jittering in a ¹D peak.

FIG. 16A shows a schematic of a microfabricated pneumatic modulator without the 40 μm wide flow resistor. The flow resistor region has the same cross section of 250 μm×250 μm (width×depth) as all other channels. FIGS. 16B-16D show magnified ¹D and ²D chromatograms of C₇. ²D flow rate=6 mL/min (FIG. 16B), 11 mL/min (FIG. 16C), and 20 mL/min FIG. 16D. For all experiments, ¹D flow rate=1.2 mL/min, loading time=0.25 s, and modulation time=2 s. Black arrows indicate the jittering in a ¹D peak.

To better understand the delay in ¹D retention time, first it is assumed that the analyte speed in the ¹D column during unmodulated operation (i.e., both valves in FIG. 1A are closed) is V₀, which is also the analyte speed in the ¹D column when the analyte is transferred from ¹D to ²D during the loading state under modulated operation when both valves are closed. During the ²D separation stage, a high auxiliary flow is served when both valves are open. The analyte speed in the ¹D column is reduced to αV₀, where a ranges from 0 to 1. If it is further assumed that the modulation time is t and the duty cycle (the ratio of the loading time and the modulation time) is m, then the analyte effective speed in the ¹D column becomes

$${V}_{eff} = {V}_{0} \times m + {aV}_{0} \times ( 1 - m ) \qquad ( 1 )$$

$$The analyte retention time is$$

$$T = \frac{L}{{V}_{eff}} = \frac{L}{{V}_{0} \times m + {aV}_{0} \times ( 1 - m )} \qquad ( 2 )$$

There are a few scenarios that can be studied. 1. Unmodulated operation. In this case, m=1, the analyte ¹D retention time is T=L/V₀. 2. Stop-flow operation. In this case, α=0, m ranges from 0-1. Consequently, the ¹D retention time becomes T=L/(mV₀) and is significantly delayed as compared to unmodulated operation. For example, when m=0.25, the ¹D retention times becomes 4 times longer. 3. Modulated operation with our pneumatic modulator. In FIGS. 17A-17C, the ¹D retention time delay is plotted with different a values (i.e., different flow rate ratios), loading times, and modulation times. In all calculations below, L=10 m and V₀=0.1 m/s is fixed.

In FIG. 17A, retention time delay is calculated from Eq. (2) as a function of a. A higher a value corresponds to a smaller flow rate ratio. Loading time=0.25 s, modulation time=2 s, m=0.125. In FIG. 17B, a retention time delay as a function of loading time. α=0.8, modulation time=2. In FIG. 17C, a retention time delay as a function of modulation time. α=0.8, loading time=0.25 s. In all calculations, L=10 m and V₀=0.1 m/s.

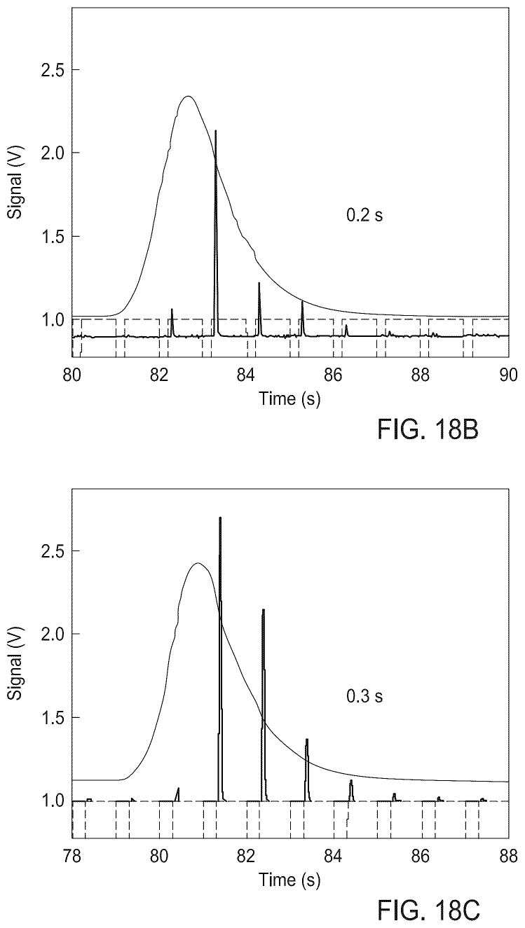

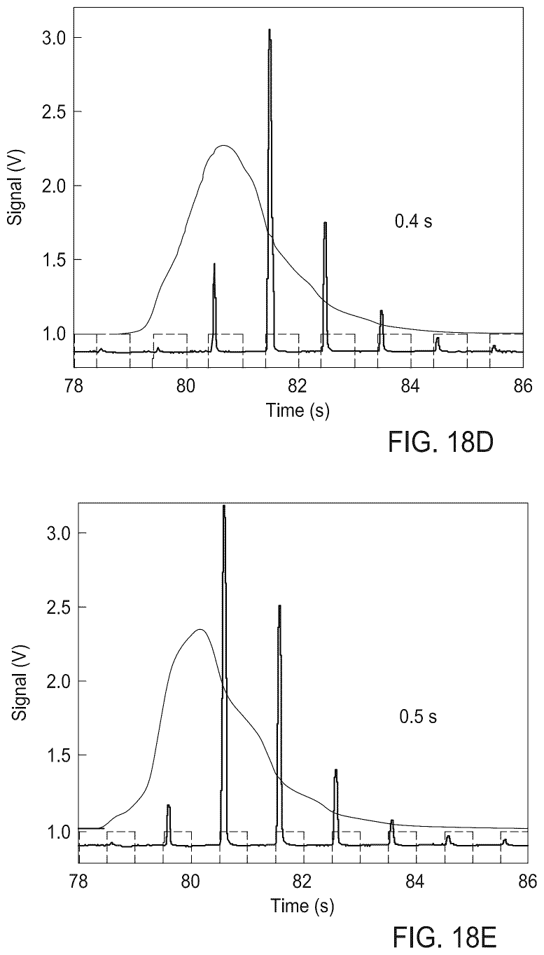

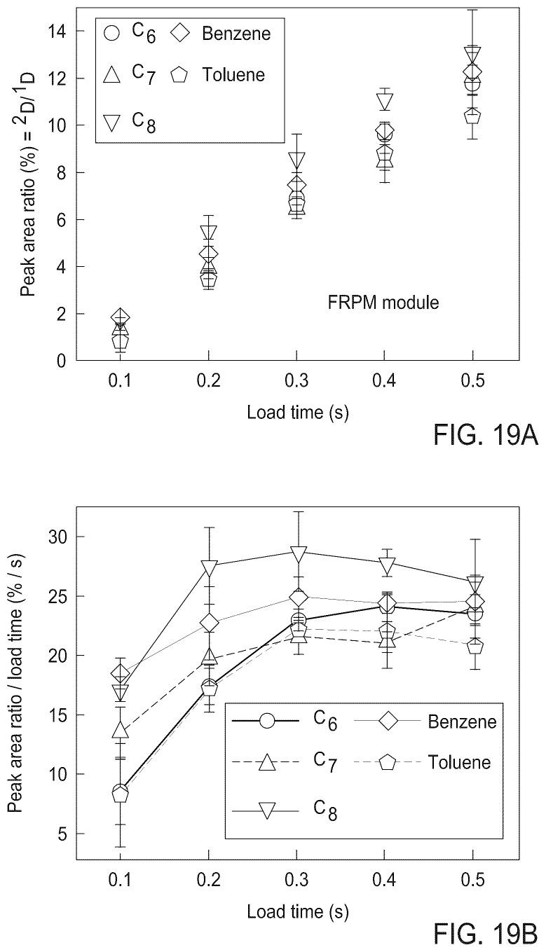

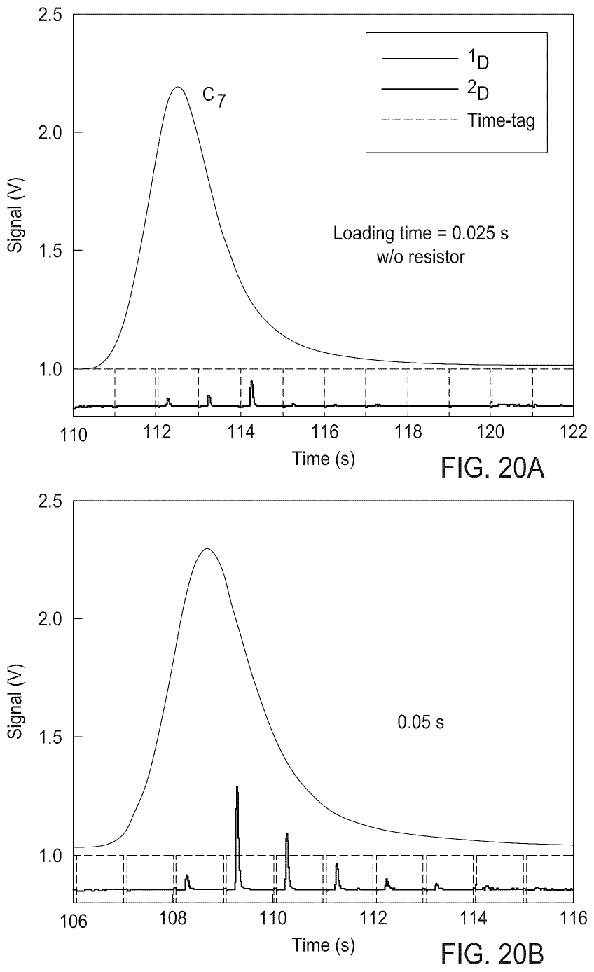

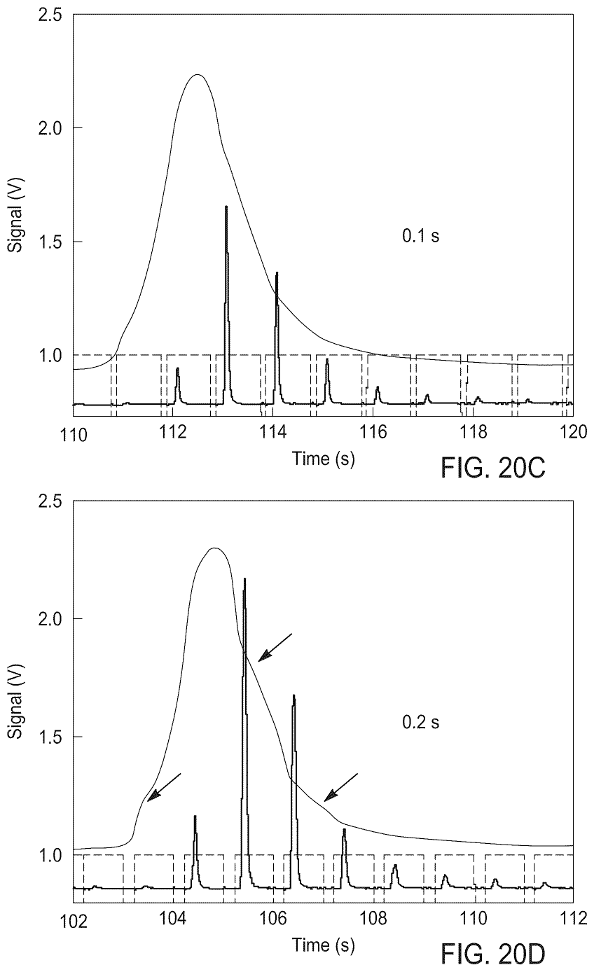

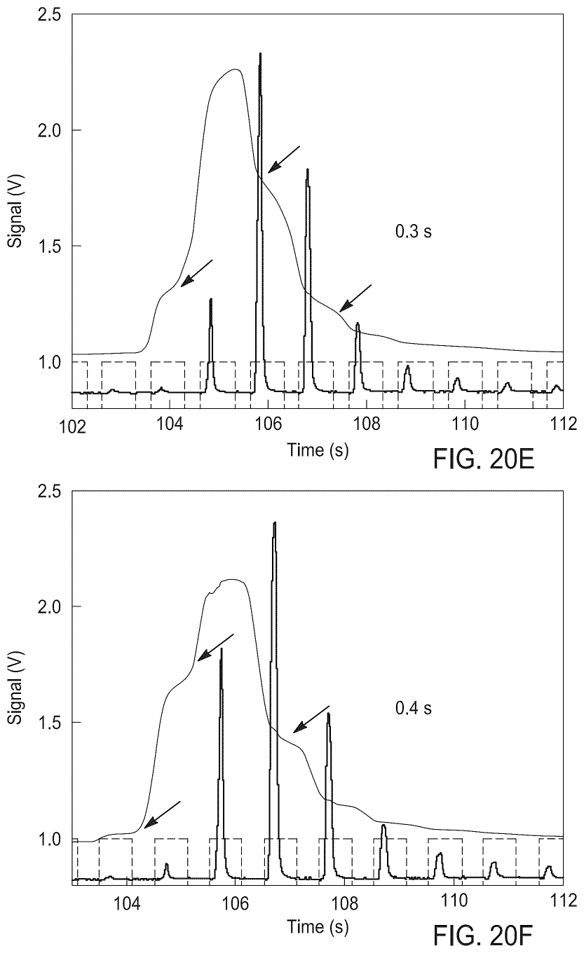

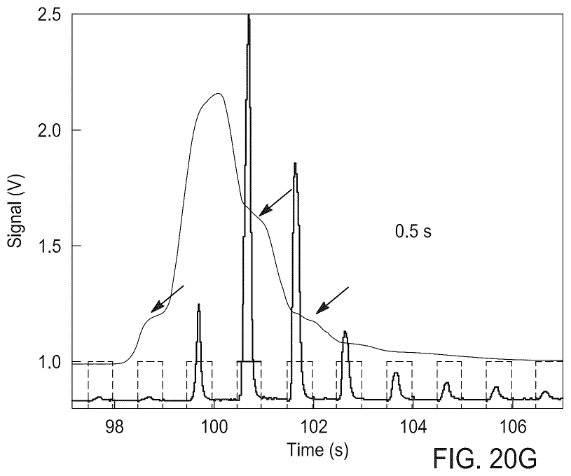

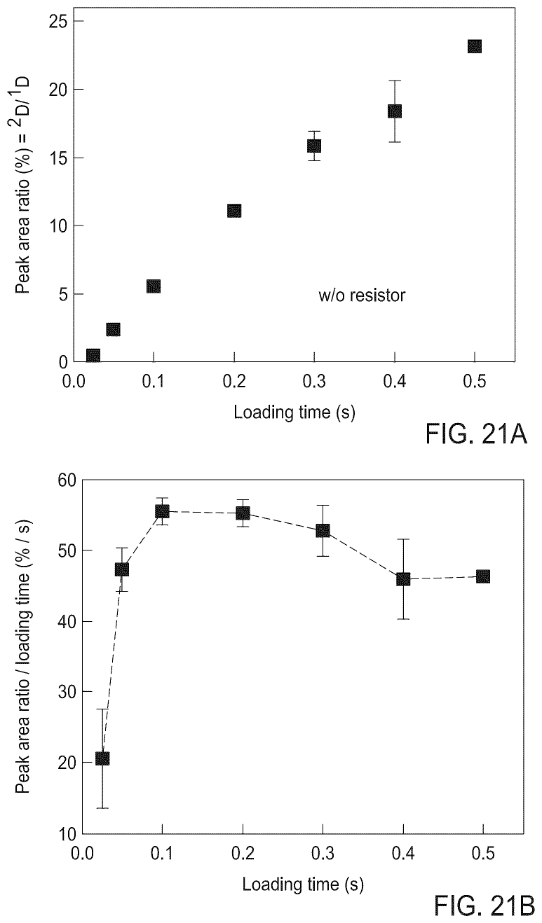

In FIGS. 18A-18E and 19A-19B, the peak area (and height) for different loading times are examined, as the loading time determines the amount of mass transferred from ¹D to ²D. It is shown in FIGS. 17A-17C that only small peaks emerge in ²D when the loading time is 0.1 s. However, the peak height increases significantly when the loading time is above 0.2 s. Since the peak height varies depending on the time when the loading from ¹D to ²D occurs, the entire ²D peak area corresponding to the same analyte peak in ¹D (there are multiple ²D peaks for a given ¹D peak) is used to estimate the total mass transfer. As expected, FIG. 19A shows that the ²D peak area, which is normalized by the corresponding ¹D peak area, increases linearly with the loading time. In FIG. 19B, the ²D peak area by the loading time is further normalized. It is found the loading time has a threshold of ~0.2 s, above which the mass transfer is nearly the same regardless of the loading time. However, below 0.2 s, the mass transfer is reduced significantly. This threshold behavior may be attributed to the minimal time required to re-establish the pressure to push the ¹D eluent through the narrow channel flow resistor when the two 2-port valves are switched from open to close. Similar threshold behavior is observed with the pneumatic modulator without the 40 μm wide flow resistor (see FIGS. 20A-20G and 21A-21B). The threshold is reduced to approximately 0.05 s, since it is easier (and quicker) to re-establish the pressure to push the ¹D eluent through a wider (250 μm) channel.

Note that pneumatic modulator chips with the flow resistor's width varying from 20 μm to 250 μm were also microfabricated and tested. The 40 μm wide flow resistor provides the optimal performance in terms of the maximally allowed ²D/¹D flow rate ratio (without causing ¹D peak distortion and significant ¹D retention time delay) and ²D injection width.

FIGS. 18A-18E show magnified ¹D and ²D chromatograms of C₇ using the FRPM module. Loading time=0.1 s (FIG. 18A), 0.2 s (FIG. 18B), 0.3 s (FIG. 18C), 0.4 s (FIG. 18D), and 0.5 s (FIG. 18E). For all experiments, modulation time=1 s, ¹D flow rate=1.2 mL/min, and ²D flow rate=16 mL/min.

FIG. 19A shows a peak area ratio of between C₇ peaks in ²D and ¹D extracted from FIGS. 18A-18E. FIG. 19B shows a peak area ratio normalized by the loading time extracted from (FIG. 19A). Error bars are obtained with 3 measurements.

FIGS. 20A-20G show magnified ¹D and ²D chromatograms of C₇ operated without flow resistor with a loading time=0.025 s (FIG. 20A), 0.05 s (FIG. 20B), 0.1 s (FIG. 20C), 0.2 s (FIG. 20D), 0.3 s (FIG. 20E), 0.4 s (FIG. 20F), and 0.5 s (FIG. 20G). For all experiments, modulation time=1 s, ¹D flow rate=1.3 mL/min, and ²D flow rate=7.5 mL/min. Black arrows indicate the jittering features in ¹D peak.

FIG. 21A shows a peak area ratio of between C₇ peaks in ²D and ¹D extracted from FIGS. 20A-20G. FIG. 21B shows a peak area ratio normalized by the loading time extracted from FIG. 21A. Error bars are obtained with 3 measurements.

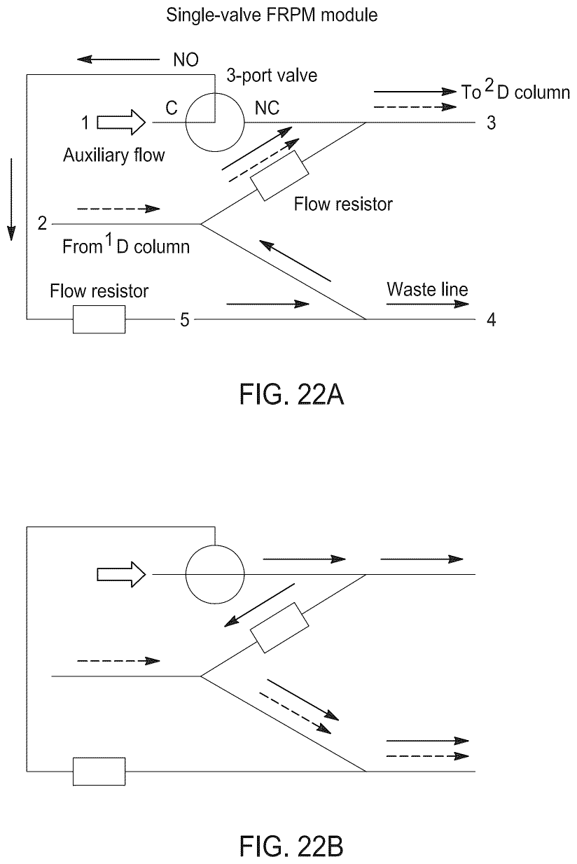

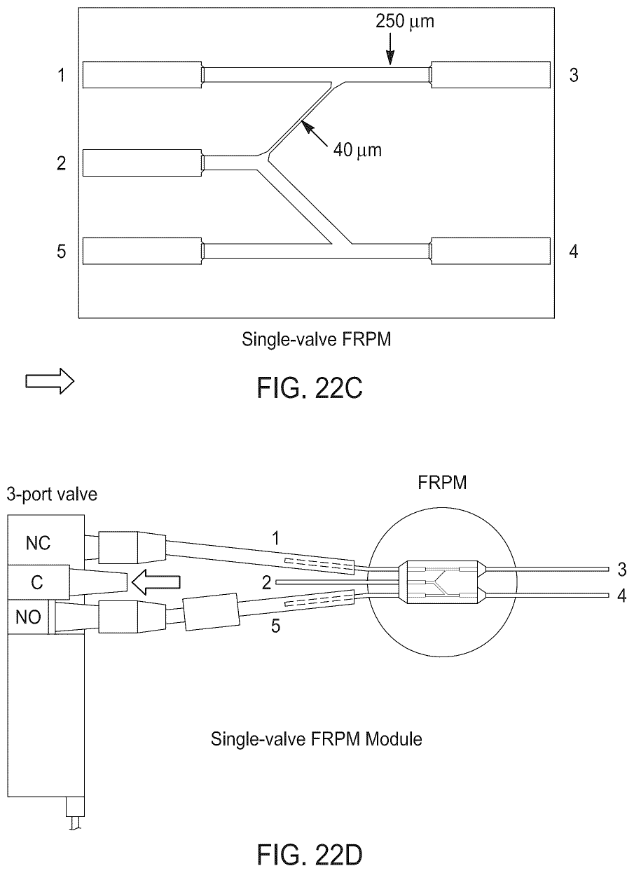

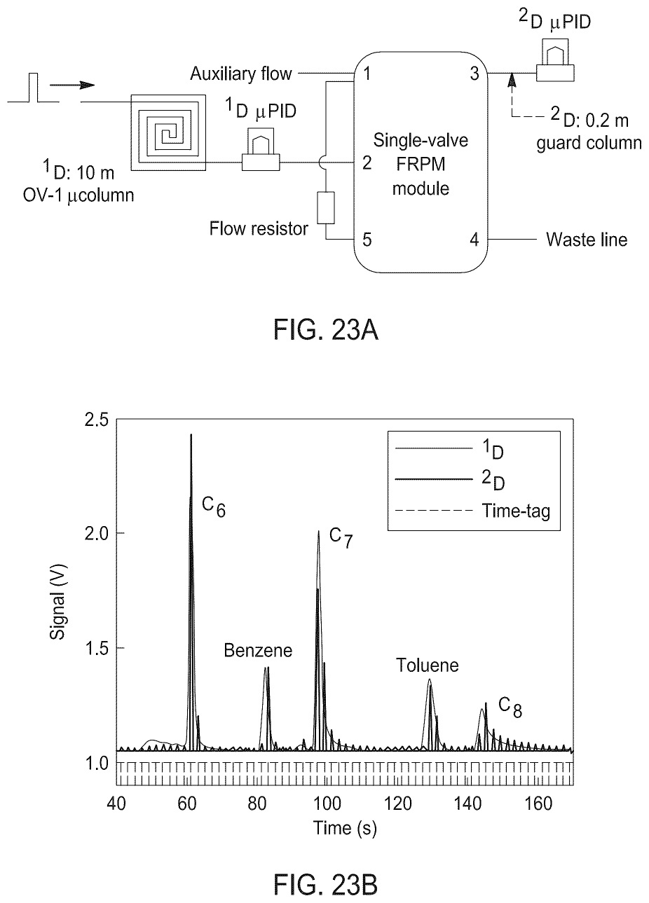

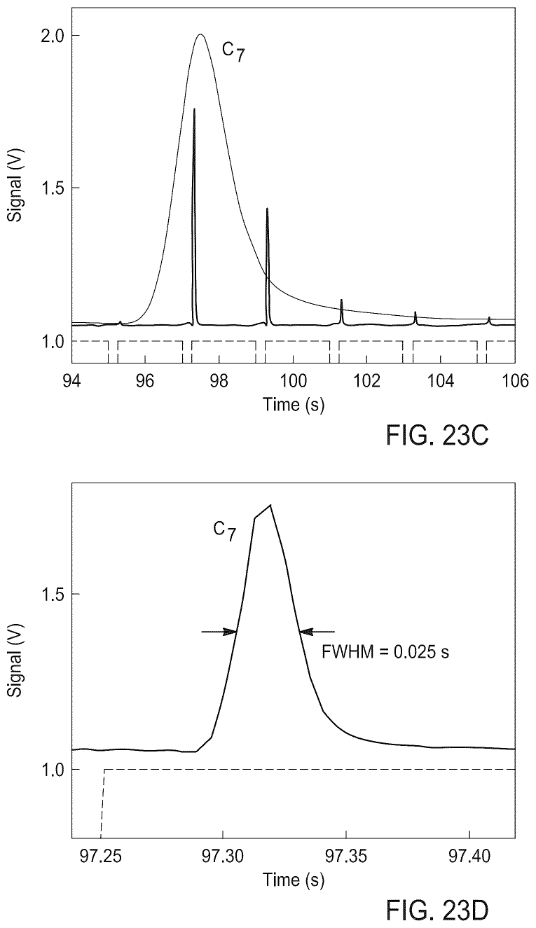

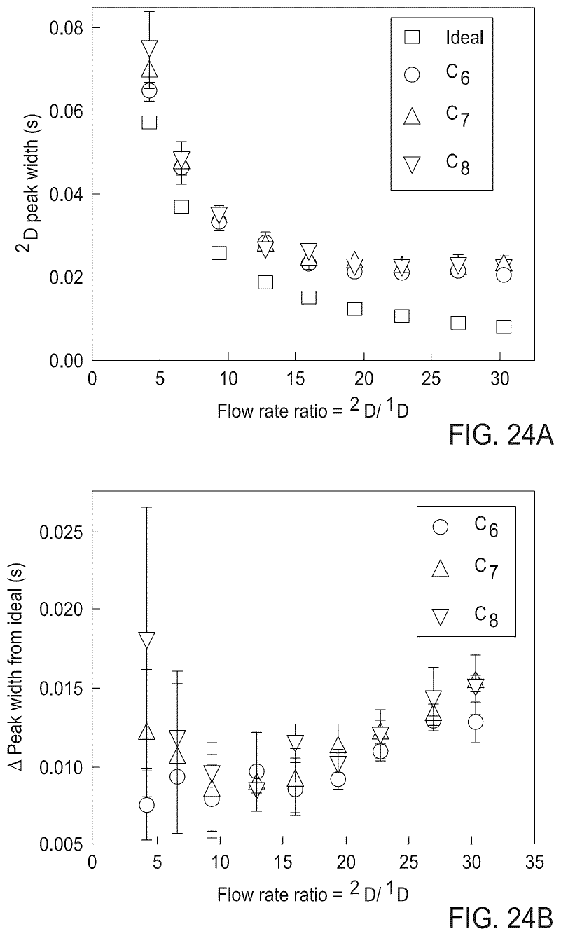

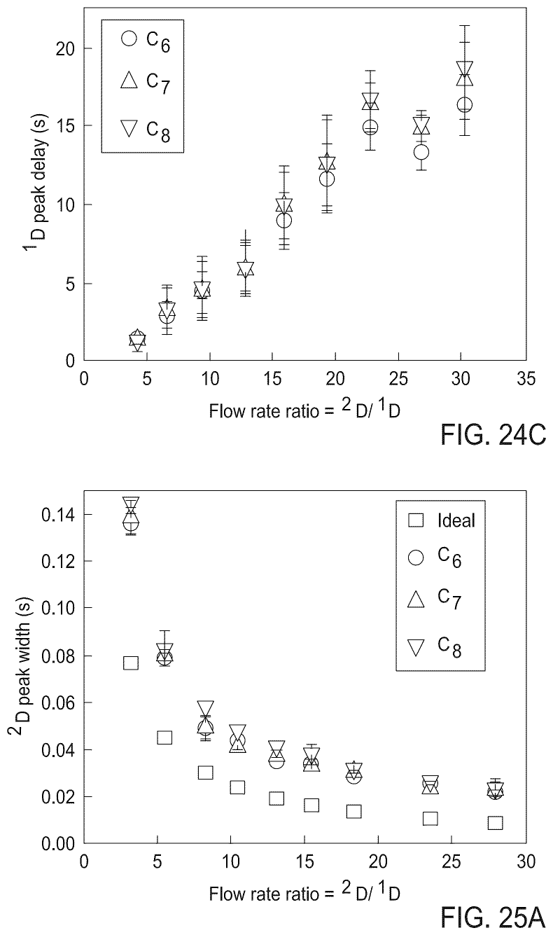

In another variation, an alternative FRPM module design prepared in accordance with certain aspects of the present disclosure replaces the two two-way 2-port valves with a single three-way/3-port valve (FIGS. 22A-22C). During ²D loading and separation, the 3-port valve directs the auxiliary flow to its normally-opened and-closed ports, respectively, allowing for similar performance to the two-valve module (FIGS. 23A-23D and 24A-24C). Compared to the two-valve configuration, the single-valve FRPM module uses fewer components, and is thus less expensive and easier to maintain. However, the eluent concentration (or density) at the transfer junction from the ¹D outlet to the ²D inlet is slightly reduced because of the additional buffer flow added to the ¹D eluents during loading.

### Integrated FRPM and ²D Microcolumn Module

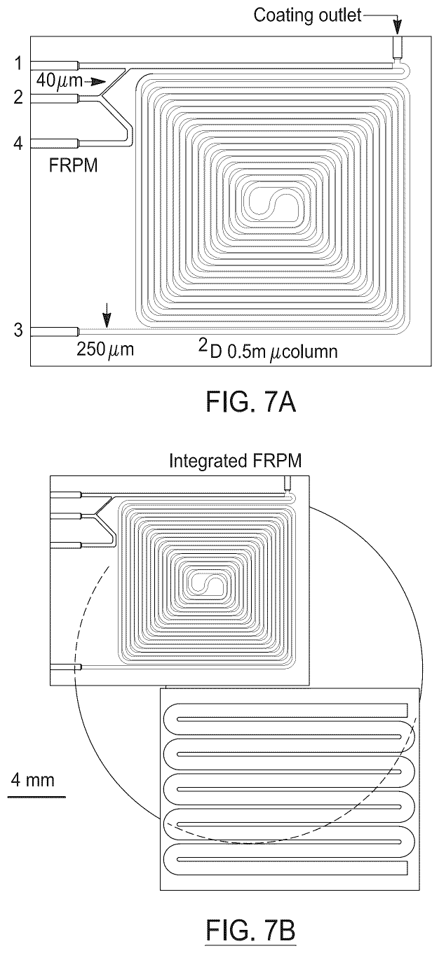

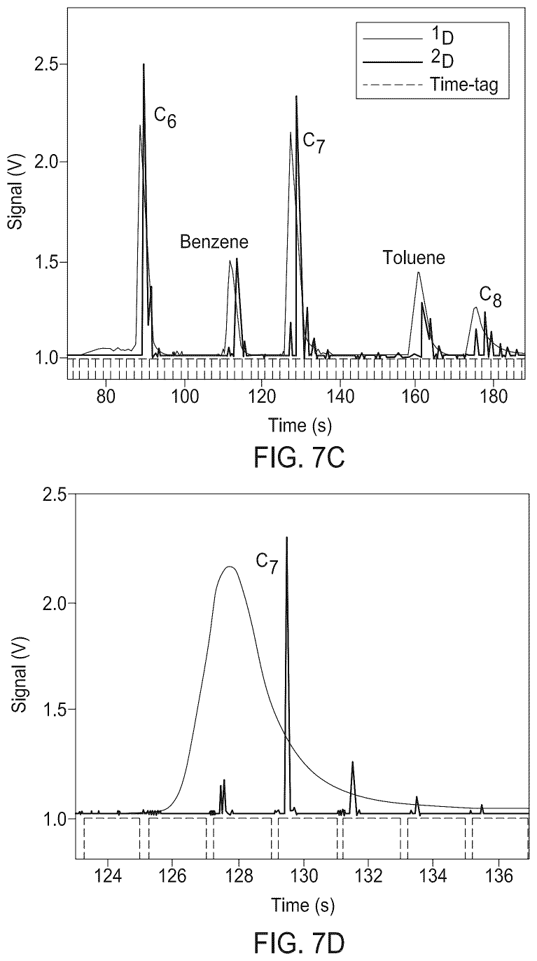

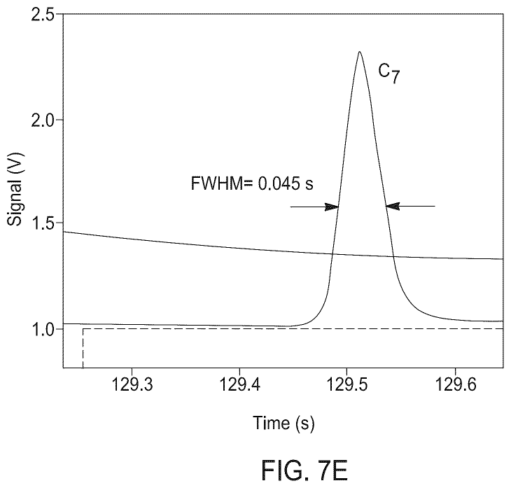

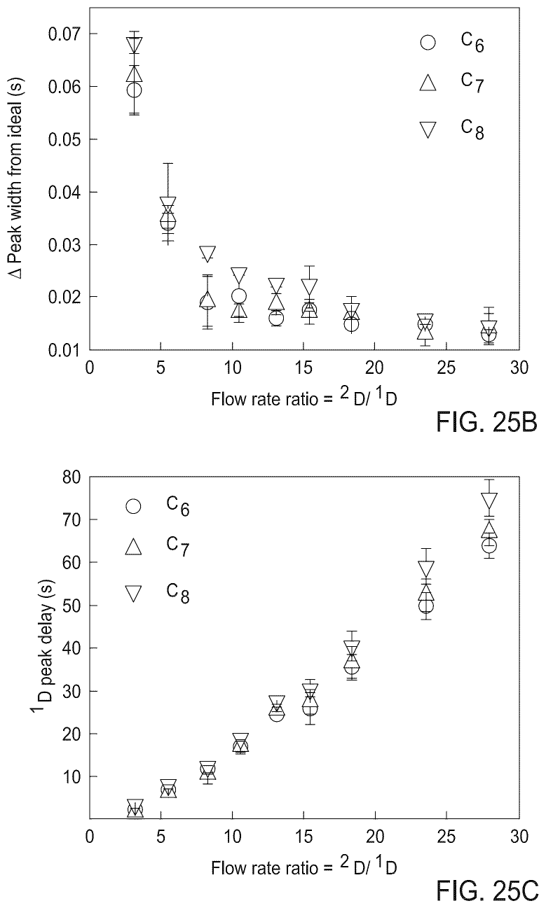

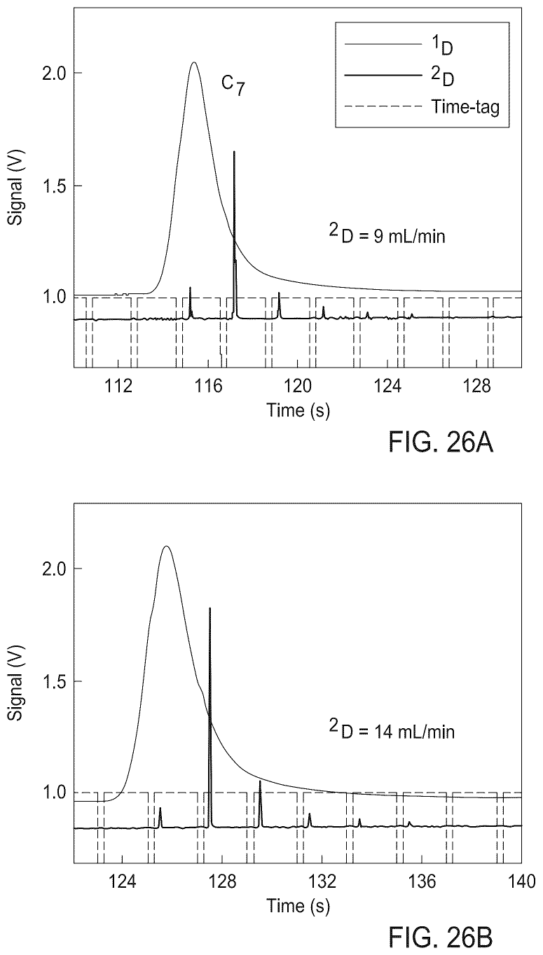

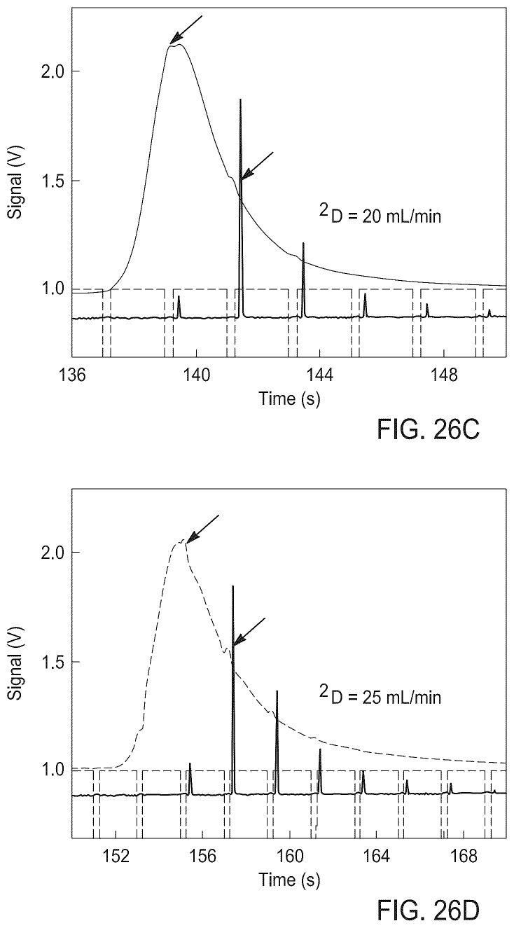

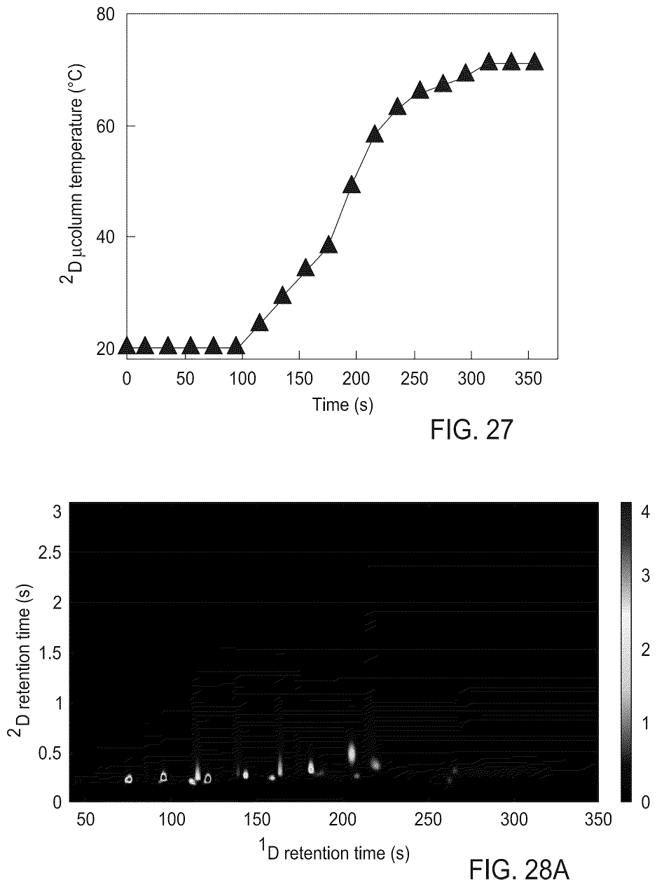

To further reduce the device footprint and number of interconnections, the FRPM was integrated with a 0.5 m ²D μcolumn (cross section: 250 μm×250 μm) on a single chip of dimensions 18 mm×15 mm×1 mm (length×width×thickness) (FIGS. 7A-7B). Because of the additional flow resistance from the 0.5 m ²D μcolumn, the integrated module was re-evaluated with the same methodology as the stand-alone module (FIGS. 25A-25C and 26A-26D). As shown in FIGS. 7C-7E, at a flow rate ratio of 13, the integrated FRPM module demonstrates similar performance to the stand-alone module with an additional ²D peak broadening of approximately 20 ms due to the extra 0.5 m microcolumn (the ²D μcolumn was only deactivated without any stationary phase coating yet).

### Automated, Portable Comprehensive 2D μGC Construction and Operation

An automated portable comprehensive 2D μGC device (FIGS. 8A-8B) that includes a 10 m OV-1 ¹D μcolumn (non-polar), the integrated FRPM and 0.5 m WAX ²D μcolumn (polar), and two flow-through μPIDs at the ¹D and ²D outlets, respectively, as well as accessories such as valves, pre-concentrator, pump, helium cartridges, and in-house control software. Miniaturized comprehensive 2D GC at the sub-system level was investigated previously using μcolumns and thermal/pneumatic modulators. However, these devices use benchtop GC injectors and/or detectors and are thus not automated stand-alone systems for field applications. In this variation, the present disclosure provides an automated portable comprehensive 2D μGC without using any benchtop components.

This comprehensive 2D μGC is different from traditional comprehensive 2D GC in a few aspects. First, traditional comprehensive ²D GC uses only one detector at the end of the ²D column. The ¹D chromatogram is reconstructed only based on information from the ²D detector, which leads to errors in ¹D retention time, ¹D peak broadening, and possibility of under-sampling of ¹D peaks. In contrast, the comprehensive 2D μGC in accordance with certain aspects of the present disclosure uses two flow-through μPIDs to monitor the ¹D and ²D eluents. This arrangement removes the need for ¹D chromatogram reconstruction, as the ¹D chromatogram can directly be obtained from the ¹D μPID. As a result, the ¹D peak position (i.e., ¹D retention time) is accurately determined and the original ¹D peak width is preserved, which improves the separation performance (i.e., peak capacity). Second, because of the two detector arrangement, a new algorithm to generate 2D contour plots was developed to improve the separation performance. Third, the modulation time is dynamically adjusted to accommodate different ¹D peak widths. For example, a short modulation time was used for earlier eluents with sharper peak widths—which reduces the chance for under-sampling—and a longer modulation time for later eluents.

The comprehensive ²D μGC device was employed to separate 40 VOCs in approximately 5 minutes in FIGS. 9A-9J. FIG. 9A shows the ¹D and modulated ²D chromatograms obtained by the ¹D and ²D μPIDs, respectively. Two zoom-ins are provided to visualize exemplary additional separations in ²D (FIGS. 9B-9E). FIG. 9F presents the 2D contour plot generated using both ¹D and ²D chromatograms obtained (as will be described further below). The 2D contour plot using the conventional method, which relies only on the ²D μPID data, is plotted in FIGS. 28A-28C. By virtue of the additional ¹D information, more peaks are identified in the same segment (e.g., FIGS. 9G and 9I compared to the conventional 2D contour plot (e.g., FIGS. 28B and 28C). As a result, all 40 VOCs are separated using the inventive methods as compared to only 32 peaks using the conventional 2D contour plot method.

Using the two detectors and the new methods significantly benefits ¹D chromatogram construction due to improved ¹D peak capacity and accuracy in ¹D peak retention time. To evaluate the increase in the ¹D peak capacity, ¹D retention times and peak widths of benzene, C₇, C₈ and C₉ are extracted from the conventional and new ²D contour plot and listed in Table 3.

TABLE 3
¹D retention times (RTs) and full-widths-at-half-maximum (FWHMs) for benzene,
C₇, C₈ and C₉ reconstructed from conventional (conv, FIG. 28A) and new (FIG. 6(F))
2D contour plots, and measured (meas) directly from the ¹D chromatogram
(FIG. 6 (A)). All values are provided in units of second.

| Analyte | RT_{conv} | FWHM_{conv} | RT_{new} | FWHM_{new} | RTₘₑₐₛ | FWHMₘₑₐₛ |
|---|---|---|---|---|---|---|
| Benzene | 85.7 | 2.7 | 84.8 | 2.6 | 84 | 2.4 |
| C₇ | 95.6 | 2.4 | 95 | 1.9 | 94.7 | 2 |
| C₈ | 143.4 | 2.5 | 142.6 | 2.3 | 142 | 2.3 |
| C₉ | 197.1 | 7.2 | 194.2 | 2.7 | 194.6 | 3.8* |

*co-elution

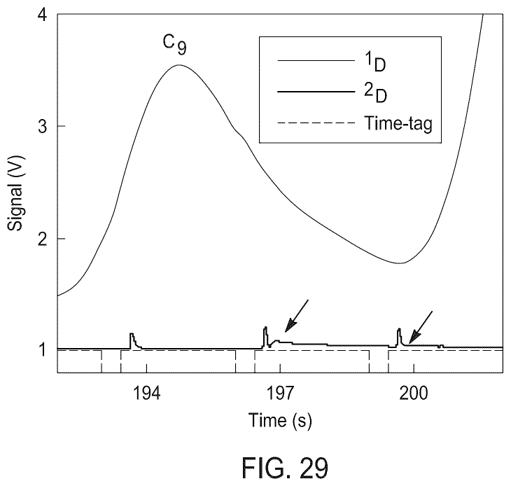

All these analytes from the new 2D contour plot have sharper peak widths than the width obtained from conventional 2D contour plot, and their widths (and retention times) are very close to the directly measured values from the ¹D chromatogram. Notably, C₉ peak width is narrower in the new reconstruction compared to the measured value, due to its co-elution in ¹D (FIG. 29). This suggests that the present algorithm was able to reconstruct the real (i.e., not co-eluted) peak for C₉ by using the ¹D data. The ¹D peak capacity of these analytes is calculated using the formula:

$${n}_{p} = \sum \frac{1.18}{{R}_{s}} \times ( \frac{{t}_{2} - {t}_{1}}{{w}_{1} + {w}_{2}} ) , \qquad ( 1 )$$

where t₁ and t₂ are the retention times for two adjacent peaks and w₁ and w₂ are the corresponding peak widths (full widths at half maximum). R₅ is the resolution. The ¹D peak capacity using the new method yields n_{p_new}=28 (Rₛ=1), showing significant improvement over the conventional method n_{p_conv}=20. In addition, accuracy in ¹D retention time is improved. For example, C₇ peak position is 94.7 s measured directly by ¹D μPID. The reconstructed peak position is 95 s using the algorithm according to certain aspects of the present disclosure, compared to 95.6 s using the conventional method.

The ²D peak capacity can be estimated as follows assuming isothermal separation:

$${n}_{p} = 1 + \frac{\sqrt{N}}{4 {R}_{s}} ln ( \frac{{t}_{r}}{{t}_{m}} ) , \qquad ( 2 )$$

where N is the theoretical plate number, tᵣ is the analyte ²D retention time, and tₘ is the hold-up time. Using C₉ (tᵣ=0.261 s, peak width=0.055 s, reconstructed from the new 2D contour plot) and holdup time of 0.17 s, nₚ=2.2 (Rₛ=1). Therefore, the peak capacity of the whole system is 62. Note that in FIGS. 9A-9J, the comprehensive ²D μGC system was optimized to separate all 40 VOCs in short time, rather than to achieve a high peak capacity.

In various aspects, the present disclosure provides a new flow-restricted pneumatic modulator (FRPM) for 2D comprehensive gas chromatography (GC) that allows for high auxiliary flow rate without disturbing or interrupting the ¹D flow, thus enabling rapid ²D injection and separation while maintaining ¹D separation and ¹D peak shape. In the FRPM, the duty cycle (i.e., the sample loading time versus modulation time) ranges from 10% to 50% (e.g., 0.2-1 s loading time in a 2 s modulation cycle), which is low compared to other valve based differential flow modulators where a duty cycle as high as 80% was used. Although this low duty cycle does not affect the present 2D μGC system due to the use of concentration dependent vapor sensors (i.e., μPIDs), the ²D signal (i.e., ²D detector's sensitivity) may be reduced if the ²D detector (e.g., flame ionization detector) depends on the mass flow rate.

An integrated FRPM is also used in constructing an automated portable comprehensive 2D μGC. Rapid separation of a diverse set of 40 VOCs in approximately 5 minutes was demonstrated. A new algorithm was developed for constructing a 2D contour plot, which incorporates both ¹D and ²D chromatograms, resulting in more accurate ¹D peak reconstructions and increased peak capacities compared to the conventional method, which uses only the ²D data. 32 peaks were counted from the conventional 2D contour plot (FIG. 28A) and 29 peaks from the ¹D chromatogram alone (FIG. 9A) compared to the 40 peaks separated by the new 2D contour plot (FIG. 9F), corresponding to a gain of 8 and 11 peaks compared to a comprehensive 2D GC using the conventional method and a single column 1D GC, respectively.

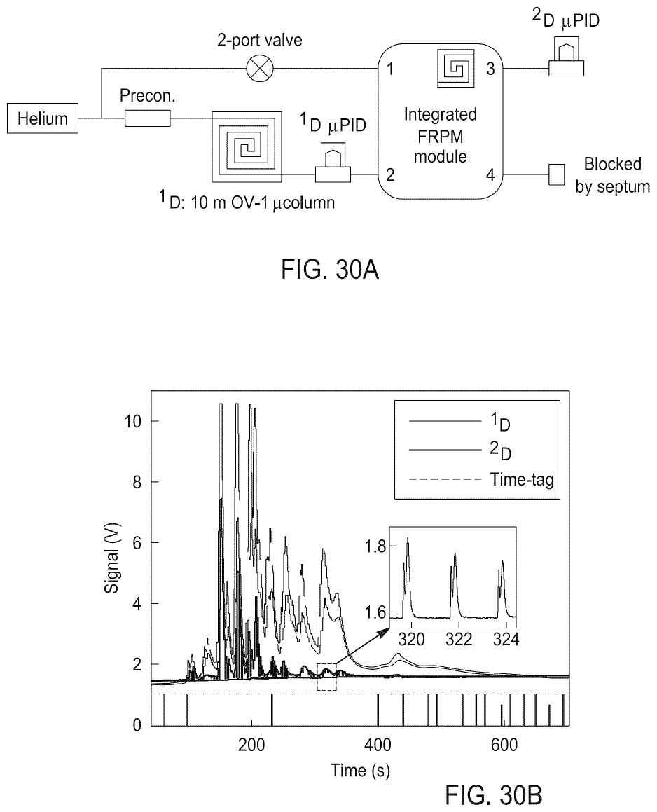

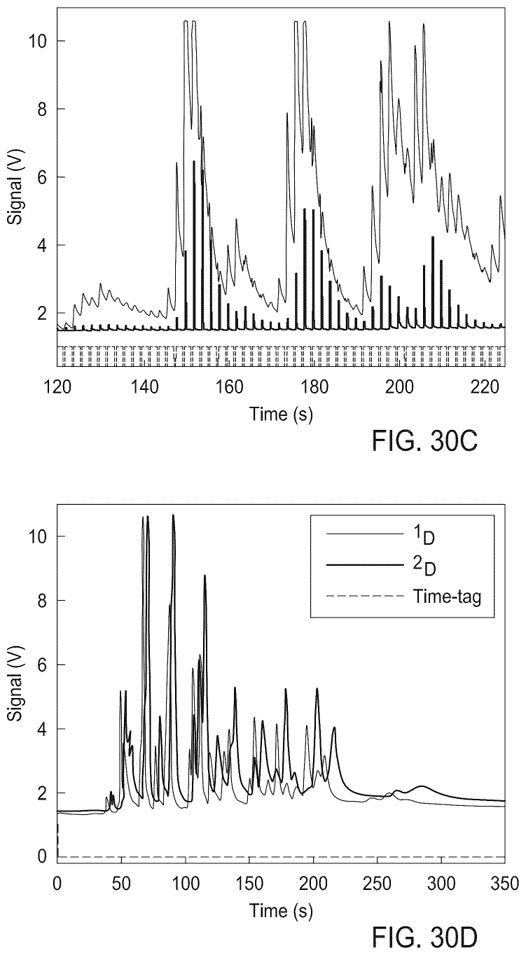

If desired, the FRPM (and hence the comprehensive 2D μGC) can be operated in stop-flow mode by permanently closing the waste/bypass line valve and letting the ¹D and auxiliary flow share the same pressure/flow source. FIGS. 30A-30D show separation of the same 40 VOCs in FIGS. 9A-9J using this mode. The ¹D separation time and peak width are both significantly increased with strong ¹D flow perturbations. While in certain operating paradigms this may be a drawback, the FRPM's flexibility of operation allowing for stop-flow mode is useful for other applications.

In various aspects, the present disclosure provides two dimensional (2D) gas chromatography (GC) devices that incorporate a flow-restricted pneumatic modulator assembly that provides enhanced vapor separation capabilities compared to conventional 1D GC and are useful for the analysis of highly complex chemical samples. In certain aspects, a microfabricated flow-restricted pneumatic modulator (FRPM) may be used for portable comprehensive 2D GC, which enables rapid ²D injection and separation without compromising ¹D separation speed and eluent peak profiles. ²D injection characteristics such as injection peak width and peak height were fully characterized by using flow-through micro-photoionization detectors (μPIDs) at the FRPM inlet and outlet. A ²D injection peak width of approximately 25 milliseconds can be achieved with a ²D/¹D flow rate ratio over 10. The FRPM was further integrated with a 0.5 m long ²D μcolumn on the same chip and its performance was characterized. Finally, an automated, portable comprehensive ²D μGC is also provided that comprises a 10 m OV-1 ¹D μcolumn, an integrated FRPM with a built-in 0.5 m polyethylene glycol (PEG) ²D μcolumn, and two μPIDs. Rapid separation of 40 volatile organic compounds in only about 5 minutes was demonstrated. A 2D contour plot was constructed by using both ¹D and ²D chromatograms obtained with the two μPIDs at the end of the ¹D and ²D μcolumns.

In summary, the present disclosure provides a first-in-kind automated portable comprehensive 2D μGC using an integrated flow-restricted pneumatic modulator (FRPM). This compact and versatile device provided portable stand-alone separations of 40 VOCs in approximately 5 minutes with an enhanced peak capacity compared to the conventional 2D GC. Further integrations of the FRPM with both ¹D and ²D μcolumns can further improve device compactness, potentially allowing for a hand-held device applicable to many more field applications.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A flow-restricted pneumatic modulator assembly for a multidimensional gas chromatography system, the flow-restricted pneumatic modulator assembly comprising:
a first y-shaped fluid connector having a first inlet, a first channel having a first outlet, and a second channel having a second outlet, wherein the first inlet is configured to receive a stream from a first chromatographic column, the first outlet is configured to be in fluid communication with a second chromatographic column, and the second outlet is configured to be in fluid communication a downstream bypass line;
a first flow resistor component disposed in the first channel having a first flow resistance to the stream, wherein the second channel has a second flow resistance that is less than the first flow resistance;
at least one flow control valve in fluid communication with the second outlet of the first y-shaped fluid connector; and
a second y-shaped fluid connector having a second inlet and a third inlet that are connected to a third channel having a third outlet, wherein the second inlet is in fluid communication with the first outlet of the first y-shaped fluid connector and configured to receive the stream from the first chromatographic column, the third inlet is configured to be in fluid communication with an auxiliary flow conduit upstream of the flow-restricted pneumatic modulator assembly and the third outlet is configured to be in fluid communication with the second chromatographic column, wherein the flow-restricted pneumatic modulator assembly is configured to be operated as an injector and a modulator to the second chromatographic column.

2. The flow-restricted pneumatic modulator assembly of claim 1, wherein the second channel comprises a second flow resistor component exhibiting the second flow resistance.

3. The flow-restricted pneumatic modulator assembly of claim 1 is formed on a substrate.

4. The flow-restricted pneumatic modulator assembly of claim 1, wherein the at least one flow control valve is a first flow control valve and the flow-restricted pneumatic modulator assembly further comprises a second flow control valve upstream of and in fluid communication with the third inlet of the second y-shaped fluid connector.

5. The flow-restricted pneumatic modulator assembly of claim 4, wherein the first flow control valve and the second flow control valve are respectively two-port valves each having an open position and a closed position.

6. The flow-restricted pneumatic modulator assembly of claim 4, wherein in a first operational mode of the flow-restricted pneumatic modulator assembly, the first flow control valve and the second flow control valve are closed to direct the stream through the first channel, the first flow resistor component, the first outlet to the third channel and third outlet and configured to direct the stream to the second chromatographic column, and in a second operational mode of the flow-restricted pneumatic modulator assembly, the first flow control valve and the second flow control valve are open to direct the stream through the second channel and the second outlet and configured to direct the stream to the bypass line, and auxiliary fluid from the auxiliary flow conduit flows through the first flow resistor component and minimizes or prevents fluid from flowing through the first channel and first outlet towards the second chromatographic column and the first flow resistor component minimizes any disturbances caused by the auxiliary fluid flow in the stream in the first chromatographic column.

7. The flow-restricted pneumatic modulator assembly of claim 1, wherein the at least one flow control valve comprises a three-way valve.

8. A multidimensional gas chromatography device, comprising:
a first chromatographic column that receives a fluid sample comprising one or more target analytes;
a flow-restricted pneumatic modulator (FRPM) assembly disposed downstream of and in fluid communication with the first chromatographic column, wherein the FRPM assembly receives a stream from the first chromatographic column and comprises:
a first y-shaped fluid connector having a first inlet, a first channel having a first outlet, and a second channel having a second outlet;
a first flow resistor component disposed in the first channel having a first flow resistance to the stream, wherein the second channel has a second flow resistance to the stream that is less than the first flow resistance;
a second y-shaped fluid connector having a second inlet, a third inlet, and a third channel having a third outlet, wherein the second inlet is in fluid communication with the first outlet of the first y-shaped connector and receives the stream from the first chromatographic column; and
at least one flow control valve;
an auxiliary fluid conduit disposed upstream of the FRPM assembly, wherein the third inlet of the second y-shaped fluid connector is in fluid communication with the auxiliary fluid conduit;
a second chromatographic column disposed downstream of the FRPM assembly and in fluid communication with the third outlet of the second y-shaped fluid connector, wherein the FRPM assembly is configured to be operated as an injector and a modulator to the second chromatographic column;
a bypass line disposed downstream of the FRPM assembly and in fluid communication with the second outlet of the first y-shaped fluid connector, wherein the at least one flow control valve controls flow of the stream to the bypass line; and
at least one detector for detecting a presence of the one or more target analytes eluted from the stream after passing through the second chromatographic column.

9. The multidimensional gas chromatography device of claim 8, wherein the at least one flow control valve is a second flow control valve in fluid communication with the second outlet of the first y-shaped fluid connector and the multidimensional gas chromatography device further comprises a first flow control valve disposed upstream of the FRPM assembly in fluid communication with the third outlet of the second y-shaped fluid connector.

10. The multidimensional gas chromatography device of claim 9, wherein the first flow control valve and the second flow control valve are respectively two-port valves each having an open position and a closed position.

11. The multidimensional gas chromatography device of claim 9, wherein in a first operational mode of the FRPM assembly, the first flow control valve and the second flow control valve are closed to direct the stream through the first channel, the first flow resistor component, the first outlet, the second inlet, and through the third channel to the third outlet to direct the stream to the second chromatographic column, and in a second operational mode of the FRPM assembly, the first flow control valve and the second flow control valve are open to direct the stream through the second channel and the second outlet and configured to direct the stream to the bypass line and the first flow resistor component minimizes or prevents fluid from flowing through the first channel and first outlet towards the second chromatographic column.

12. The multidimensional gas chromatography device of claim 8, wherein the at least one flow control valve comprises a three-way valve.

13. The multidimensional gas chromatography device of claim 8, wherein the FRPM assembly further comprises a second flow resistor component disposed in the second channel of the first y-shaped fluid connector, the second flow resistor component having the second flow resistance that is less than the first flow resistance.

14. The multidimensional gas chromatography device of claim 8 further comprising a substrate, wherein the FRPM assembly is formed in the substrate.

15. The multidimensional gas chromatography device of claim 8, wherein the substrate further comprises:
(i) the first chromatographic column upstream of the FRPM assembly;
(ii) the second chromatographic column downstream of the FRPM assembly; or
(iii) the first chromatographic column upstream of the FRPM assembly and the second chromatographic column downstream of the FRPM assembly.

16. The multidimensional gas chromatography device of claim 8, wherein the at least one detector comprises a photoionization detector (PID).

17. The multidimensional gas chromatography device of claim 8, further comprising a second detector disposed downstream of the first chromatographic column and upstream of the first inlet of the FRPM assembly.

18. The multidimensional gas chromatography device of claim 8, wherein the first chromatographic column is a first micro-gas chromatographic column and the second chromatographic column is a second micro-gas chromatographic column, wherein the multidimensional gas chromatography device is portable.

19. A method of chromatographic analysis of a fluid sample comprising one or more target analytes in a multidimensional chromatography system, the method comprising:
separating the one or more target analytes in the fluid sample in a first chromatographic column;
directing a stream exiting the first chromatographic column toward a flow-restricted pneumatic modulator (FRPM) assembly that operates as an injector and a modulator to a downstream second chromatographic column, the flow-restricted pneumatic modulator comprising:
a first y-shaped fluid connector having a first inlet, a first channel having a first outlet, and a second channel having a second outlet;
a first flow resistor component disposed in the first channel having a first flow resistance to the stream, wherein the second channel has a second flow resistance to the stream that is less than the first flow resistance;
a second y-shaped fluid connector having a second inlet, a third inlet, and a third channel having a third outlet, wherein the second inlet is in fluid communication with the first outlet of the first y-shaped connector and receives the stream from the first chromatographic column; and
at least one flow control valve;
operating the FRPM assembly in a first operational mode for a first duration where the at least one flow control valve is closed to selectively direct the stream through the first channel, through the first flow resistor component, through the first outlet to the second inlet through the third channel and third outlet to a second chromatographic column; and
operating the FRPM assembly in a second operational mode for a second duration where the at least one flow control valve is open to direct the stream through the second channel and the second outlet and to a downstream bypass line.

20. The method of claim 19, wherein the at least one flow control valve comprises a first flow control valve in fluid communication with the second outlet of the first y-shaped fluid connector upstream of the bypass line and a second flow control valve in fluid communication with the third inlet of the second y-shaped fluid connector, wherein the first flow control valve and the second flow control valve are respectively two-port valves each having an opened position and a closed position.

21. The method of claim 19, wherein the first duration is less than or equal to about 0.2 seconds.

22. The method of claim 19, wherein in the first operational mode, the second chromatographic column has a peak injection width of less than or equal to about 25 milliseconds.

23. The method of claim 19, wherein a first flow rate of the stream in the first operational mode is less than or equal to about 0.5 mL/minute and a flow rate of the stream in the second operational mode is greater than or equal to about 1 mL/minute.

24. The method of claim 19, wherein the multidimensional chromatography system further comprises an auxiliary fluid conduit upstream of the FRPM assembly, wherein the at least one flow control valve comprise a first flow control valve and a second flow control valve that is configured to receive auxiliary fluid from the auxiliary fluid conduit upstream of the third inlet of the second y-shaped fluid connector and the auxiliary fluid conduit is in fluid communication with the second chromatographic column, so that in the second operational mode, the auxiliary fluid flows through the first flow resistor component and minimizes or prevents fluid from flowing through the first channel and first outlet towards the second chromatographic column and the first flow resistor component minimizes any disturbances caused by the auxiliary fluid flow in the stream in the first chromatographic column.

25. The method of claim 24, wherein the stream entering the second chromatographic column during the first operational mode has a first flow rate and the auxiliary fluid entering the second chromatographic column during the second operational mode has a second flow rate, wherein a ratio of the second flow rate to the first flow rate is greater than or equal to about 10:1.

26. The method of claim 19, further comprising repeating the operating the FRPM assembly in the first operational mode for the first duration and the operating the FRPM assembly in the second operational mode for the second duration.

27. The method of claim 26, wherein the FRPM assembly has a duty cycle of greater than or equal to about 1% to less than or equal to about 50%.

28. The method of claim 19, further comprising detecting one or more target analytes in a secondary stream exiting the second chromatographic column.

29. The method of claim 28, further comprising detecting one or more target analytes in the stream exiting the first chromatographic column.
